(19) United States
(12) Patent Application Publication
(10) Pub. No.: US 2023/0223597 A1
(43) Pub. Date: Jul. 13, 2023

(54) CAPACITY-COMPENSATION ELECTROLYTE ADDITIVE, PREPARATION METHOD AND APPLICATION, ELECTROLYTE CONTAINING THE SAME, AND SECONDARY BATTERY

(71) Applicant: TIANJIN UNIVERSITY, Tianjin (CN)

(72) Inventors: Jie SUN, Tianjin (CN); Xiaoyi WANG, Tianjin (CN)

(21) Appl. No.: 17/980,265

(22) Filed: Nov. 3, 2022

(30) Foreign Application Priority Data
Jan. 10, 2022 (CN) 202210023328X

(51) Int. Cl. H01M 10/0567; H01M 10/0525; H01M 10/054; H01M 10/0569

(52) U.S. Cl. CPC H01M 10/0567; H01M 10/0525; H01M 10/054; H01M 10/0569; H01M 2300/0028

(57) ABSTRACT

The present disclosure discloses a capacity-compensation electrolyte additive and electrolyte having the same, the additive comprises one or more of LiₓP_{y}, NaₘPₙ and KₚP_{q}, where 0<x≤3, 0<y≤11, 0<m≤3, 0<n≤11, 0<p≤3 and 0<q≤11, the electrolyte is applied to a lithium-ion battery, a sodium-ion battery or a potassium-ion battery. The additive can decompose active ions and electrons during whole charge-discharge cycle, and improves the initial Coulombic efficiency of the battery, specific capacity and cycling stability, so as to achieve uniform capacity compensation; and the additive is dissolved prior to electrolyte solvents, the products stabilize both of cathode and anode solid electrolyte layer, and improve capacity retention ratio in batteries so as to achieve stable cycling. Adding additive in electrolyte will not hazard electrode structure, can achieve uniform capacity compensation, has higher safety and easy to implement.

### CROSS-REFERENCE TO RELATED APPLICATION

This application claims priority from the Chinese patent application 202210023328X filed Jan. 10, 2022, the content of which are incorporated herein in the entirety by reference.

### TECHNICAL FIELD

The present disclosure relates to the field of secondary batteries, and mainly relates to the field of electrolytes for lithium-ion batteries, sodium-ion batteries and potassium-ion batteries, in particular to preparation and application of a multifunctional electrolyte additive for a lithium-ion battery, a sodium-ion battery and a potassium-ion battery.

### BACKGROUND

In recent years, with the rapid development of portable electronic products and electric vehicles, the development of secondary batteries has attracted much attention. The secondary batteries have the advantages of higher energy density, low environmental pollution and no memory effect. However, the secondary batteries applied to the electric vehicles are still facing great challenges of “range anxiety”, cycle stability and safety performance.

In the first charging cycle of the secondary batteries, electrolytes are decomposed to form a solid electrolyte interphase (SEI) on the surface of an anode and a cathode electrolyte interphase (CEI) on the surface of a cathode. In this process, active ions in the batteries are consumed irreversibly, resulting in the lower initial Coulombic efficiency of the batteries, which reduces the capacity and energy density of the batteries. For silica-based anodes, phosphorus-based anodes and the like featuring alloying reaction mechanisms with higher theoretical specific capacities, a larger volume expansion ratio of the anodes in a cyclic process may cause pulverization, resulting in generation of dead lithium/sodium/potassium; and for metal oxide anodes and the like featuring conversion reaction mechanisms, the product thereof in the process is low in electronic conductivity, and a deioning process also prone to generate the dead lithium/sodium/potassium, resulting in loss of active ions.

In order to further improve the energy density of the secondary batteries, researchers turned their attention to the development of high-voltage cathode materials with high specific capacity, such as LiCoO₂, LiNiO₂, LiMn₂O₄, LiNi_{0.5}Mn_{1.5}O₄, LiNiₐCo_{b}Mn_{1-a-b}O₂, LiNi_{c}Co_{d}Al_{1-c-d}O₂ and the like in the lithium-ion batteries (where 0<a, b, c, d<1), and the cutoff voltage of the materials can reach 4.2 V to 4.3 V. However, under high-voltage conditions, especially when the voltage reaches 4.5 V and above, common carbonic ester electrolytes may be oxidatively decomposed seriously, which causes a rapid reduction in the battery capacity. For example, Li/Ni cation mixing, dissolution of transition metals, oxygen evolution and other phenomena may occur to ternary materials under high voltage, and the cycle stability and service life of the batteries are affected.

For the above problems, some researchers proposed pre-lithiation of the cathodes, the anodes and the electrolytes. For example, CN 110400985A discloses an anode lithium-compensating film consisting of lithium powder or lithium particles and organic binders. However, the lithium powder has certain potential safety hazards in practical production, and the use of additional binders may reduce the overall energy density of the batteries. Wherein, for the pre-lithiation of the electrolytes, a general method is to add lithium salts capable of decomposing to release lithium ions to electrolyte solvents. However, some lithium salts have the problems that the solubility in the electrolyte solvent is low and additives need to be added additionally; for example, in CN112448037, lithium nitride and/or lithium oxalate serves as a lithium-compensating compound, and meanwhile tri(pentafluorophenyl) borane, tri(pentafluorophenyl) phosphine or tri(pentafluorophenyl) silane is required as a cosolvent. In the patent CN 113258139 A, besides lithium acetate, lithium trifluoroacetate and n-butyllithium for supplying lithium sources, the electrolyte needs to be used in combination with a first solvent for prelithiation and a second solvent for preventing co-intercalation, so that the formula of the electrolyte is complex.

### SUMMARY

A first technical problem to be solved by the present application is to provide a capacity-compensation electrolyte additive. Generally, lithium-compensating additives are only available for loss of active ions in a first charge-discharge cycle, and have the problem of low compatibility with electrolyte solvents. However, the capacity-compensation electrolyte provided by the present application can compensate the loss of the active ions and electrons due to volume expansion and other reasons in the whole cycle life of a battery. Compensation of the active ions by means of the electrolyte additive will not pose an adverse impact on an electrode structure. The compatibility with common electrolyte solvents, electrolyte salts and anode and cathode materials is higher. The electrolyte may decompose in an operating voltage window of the battery to achieve uniform compensation of the ions and the electrons in each process of the battery cycles, and the safety and operability are higher.

The additive may decompose prior to the electrolyte solvents and the electrolyte salts to release the active ions and the electrons for compensating the capacity loss occurred in the first cycle and subsequent cycle processes of the battery, and therefore the cycle stability and energy density of the batter are improved.

Another technical problem to be solved by the present application is to provide application of a phosphorus-containing substance as the electrolyte additive. Compared with the electrolyte solvents and the electrolyte salts, the phosphorus-containing substance has a lower LUMO (lowest unoccupied molecular orbital) energy level and a higher HOMO (highest occupied molecular orbital) energy level, and may preferentially decompose to release the active ions and the electrons. The phosphorus-containing ions may participate in formation of SEI and CEI of an electrode to achieve stable cycling of the electrode.

Another technical problem to be solved by the present application is to provide a preparation method of the phosphorus-containing substance. Lithium polyphosphide is synthesized by a liquid-solid reaction at a certain temperature, and the liquid-solid reaction is milder and more uniform compared with a solid-solid reaction requiring high temperature.

Another technical problem to be solved by the present application is to provide an electrolyte for a secondary battery. The electrolyte contains the above capacity-compensation electrolyte additive, has wide applicability, can be applied to most existing lithium/sodium/potassium secondary battery systems, and improves the cycle stability and energy density of the battery.

Another technical problem to be solved by the present application is to provide a preparation method of the electrolyte for the secondary battery. The preparation process includes the process of dissolving an electrolyte salt in a solvent, adding the capacity-compensation electrolyte additive in an inert gas atmosphere, and adding the electrolyte additive serving as an electrolyte to the secondary battery. The preparation process is compatible with an existing industrial production process.

The other technical problem to be solved by the present application is to provide a secondary ion battery. The secondary ion battery contains the capacity-compensation electrolyte, which has high cycle stability.

The term “capacity-compensation” used in the present disclosure refers to compensation for capacity losses caused by various reasons such as pulverization of electrode materials in a first-cycle electrode-electrolyte interface side reaction of the secondary battery, SEI and CEI formed during the side reaction and the follow-up cycle process, including active ions and electrons generated by decomposition of the additive.

In order to solve the first problem of the present application, the present application adopts the following technical solutions:

A capacity-compensation electrolyte additive includes one or more of LiₓP_{y}, NaₘPₙ and KₚP_{q}, where 0<x≤3, 0<y≤11, 0<m≤3, 0<n≤11, 0<p≤3 and 0<q≤11.

As a further improvement of a technical solution, preferably, 1<x<3, 4≤y≤10, 1≤m<3, 4≤n≤10, 1≤p≤3 and 4≤q≤10. Where, x, y, m, n, p and q may be integers or fractions.

As a further improvement of the technical solution, the LiₓP_{y} is selected from one or more of LiP₄, LiP₅, LiP₇, LiP₈ and LiP₁₀.

As a further improvement of the technical solution, the LiₓP_{y} is selected from one or more of LiP₈ and LiP₇.

As a further improvement of the technical solution, the NaₘPₙ is selected from one or more of NaP₄, NaP₅, NaP₇ and NaP₁₀;

As a further improvement of the technical solution, the NaₘPₙ is selected from one or more of NaP₅ and NaP₇.

As a further improvement of the technical solution, the KₚP_{q} is selected from one or more of KP₄, KP₅, KP₇ and K₃P₇; and

As a further improvement of the technical solution, the KₚP_{q} is selected from one or more of KP₅ and K₃P₇.

As a further improvement of the technical solution, the above additive may be dissolved in the electrolyte, and the above additive and electrolyte are applied to the secondary battery.

As a further improvement of the technical solution, the secondary battery includes a lithium-ion battery, a sodium-ion battery or a potassium-ion battery.

The present application further provides a preparation method of the above capacity-compensation electrolyte additive. The additive includes one or more of the LiₓP_{y}, the NaₘPₙ and the KₚP_{q}, and the preparation method includes the steps of adding red phosphorus to a Li-biphenyl solution, a Na-biphenyl solution or a K-biphenyl solution according to a certain proportion respectively, and stirring the solution at a certain temperature to obtain a LiₓP_{y} solid, a NaₘPₙ solid and a KₚP_{q} solid by centrifuging and evaporating solvents to dryness.

In order to solve the other problem of the present application, the present application adopts the following technical solutions:

Provided is application of the phosphorus-containing substance as the electrolyte additive in the electrolyte preparation, and the phosphorus-containing substance includes one or a combination of more of the LiₓP_{y}, the NaₘPₙ and the KₚP_{q}; the phosphorus-containing substance is dissolved in the electrolyte;

Where, 0<x≤3, 0<y≤11, 0<m≤3, 0<n≤11, 0<p≤3 and 0<q≤11.

As a further improvement of the technical solution, the application includes: soaking and dissolving one or more of the LiₓP_{y}, the NaₘPₙ and the KₚP_{q} in an electrolyte solvent to obtain the electrolyte containing the additive.

As a further improvement of the technical solution, the phosphorus-containing substance includes the LiₓP_{y}; the preparation method and application method of the LiₓP_{y} serving as the additive include:

adding the red phosphorus to the Li-biphenyl solution, and stirring the solution at a certain temperature to obtain the LiₓP_{y} solid by centrifuging and evaporating the solvent to dryness; adding the electrolyte salt to the electrolyte solvent and dissolving the electrolyte salt, and then soaking and dissolving the LiₓP_{y} solid in the electrolyte solvent to obtain the electrolyte with the LiₓP_{y} dissolved. Wherein, the optional solvent of the Li-biphenyl solution is one or more of the tetrahydrofuran, the dimethoxyethane, the tetraethylene glycol dimethyl ether and the diglyme.

As a further improvement of the technical solution, the additive is added to the electrolyte in the inert gas atmosphere, such as the argon atmosphere.

As a further improvement of the technical solution, the solvent of the Li-biphenyl solution is selected from the tetrahydrofuran or the dimethoxyethane.

As a further improvement of the technical solution, a concentration of the Li-biphenyl solution ranges from 0.2 mol/L to 2.0 mol/L;

As a further improvement of the technical solution, the concentration of the Li-biphenyl solution ranges from 0.8 mol/L to 1.2 mol/L;

As a further improvement of the technical solution, the concentration of the Li-biphenyl solution ranges from 1.0 mol/L to 1.1 mol/L;

As a further improvement of the technical solution, a molar ratio of the amount of the red phosphorus added to the Li-biphenyl solution to Li ranges from 1:3 to 11:1;

As a further improvement of the technical solution, the molar ratio of the amount of the red phosphorus added to the Li-biphenyl solution to Li ranges from 1:3 to 5:1;

As a further improvement of the technical solution, the molar ratio of the amount of the red phosphorus added to the Li-biphenyl solution to the Li ranges from 1:3 to 7:3.

As a further improvement of the technical solution, a stirring time of the Li-biphenyl solution with the red phosphorus added ranges from 2 hours to 30 hours;

As a further improvement of the technical solution, the stirring time of the Li-biphenyl solution with the red phosphorus added ranges from 6 hours to 15 hours;

As a further improvement of the technical solution, the stirring time of the Li-biphenyl solution with the red phosphorus added ranges from 10 hours to 12 hours;

As a further improvement of the technical solution, a stirring condition of the Li-biphenyl solution with the red phosphorus added ranges from 25° C. to 40° C.; and

As a further improvement of the technical solution, the stirring condition of the Li-biphenyl solution with the red phosphorus added ranges from 25° C. to 35° C.

As a further improvement of the technical solution, soaking time of the LiₓP_{y} solid in the electrolyte ranges from 6 hours to 48 hours;

As a further improvement of the technical solution, the soaking time of the LiₓP_{y} solid in the electrolyte ranges from 12 hours to 30 hours;

As a further improvement of the technical solution, the soaking time of the LiₓP_{y} solid in the electrolyte ranges from 20 hours to 24 hours.

As a further improvement of the technical solution, the amount of the LiₓP_{y} solid soaked in the electrolyte ranges from 0.2 g/L to 10.0 g/L;

As a further improvement of the technical solution, the amount of the LiₓP_{y} solid soaked in the electrolyte ranges from 1.0 g/L to 5.0 g/L;

As a further improvement of the technical solution, the amount of the LiₓP_{y} solid soaked in the electrolyte ranges from 1.2 g/L to 3.0 g/L.

As a further improvement of the technical solution, the phosphorus-containing substance includes the NaₘPₙ; the preparation method and application method of the NaₘPₙ serving as the additive include:

adding the red phosphorus to the Na-biphenyl solution, and stirring the solution at a certain temperature to obtain the NaₘPₙ solid by centrifuging and evaporating the solvent to dryness; and adding the electrolyte salt to the electrolyte solvent and dissolving the electrolyte salt, and then soaking and dissolving the NaₘPₙ solid in the electrolyte solvent to obtain the electrolyte with the NaₘPₙ dissolved. Wherein, the optional solvent of the Na-biphenyl solution is one or more of the tetrahydrofuran, the dimethoxyethane, the tetraethylene glycol dimethyl ether and the diglyme.

As a further improvement of the technical solution, the additive is added to the electrolyte in the inert gas atmosphere, such as the argon atmosphere.

As a further improvement of the technical solution, the solvent of the Na-biphenyl solution is selected from the tetrahydrofuran or the dimethoxyethane.

As a further improvement of the technical solution, the concentration of the Na-biphenyl solution ranges from 0.2 mol/L to 2.0 mol/L;

As a further improvement of the technical solution, the concentration of the Na-biphenyl solution ranges from 0.8 mol/L to 1.2 mol/L;

As a further improvement of the technical solution, the concentration of the Na-biphenyl solution ranges from 1.0 mol/L to 1.1 mol/L;

As a further improvement of the technical solution, the molar ratio of the amount of the red phosphorus added to the Na-biphenyl solution to Na ranges from 1:3 to 11:1;

As a further improvement of the technical solution, the molar ratio of the amount of the red phosphorus added to the Na-biphenyl solution to Na ranges from 1:3 to 5:1;

As a further improvement of the technical solution, the molar ratio of the amount of the red phosphorus added to the Na-biphenyl solution to the Na ranges from 1:3 to 7:3.

As a further improvement of the technical solution, a stirring time of the Na-biphenyl solution with the red phosphorus added ranges from 2 hours to 30 hours;

As a further improvement of the technical solution, the stirring time of the Na-biphenyl solution with the red phosphorus added ranges from 6 hours to 15 hours;

As a further improvement of the technical solution, the stirring time of the Na-biphenyl solution with the red phosphorus added ranges from 10 hours to 12 hours.

As a further improvement of the technical solution, the stirring condition of the Na-biphenyl solution with the red phosphorus added ranges from 25° C. to 40° C.; and

As a further improvement of the technical solution, the stirring condition of the Na-biphenyl solution with the red phosphorus added ranges from 25° C. to 35° C.

As a further improvement of the technical solution, soaking time of the NaₘPₙ solid in the electrolyte ranges from 6 hours to 48 hours;

As a further improvement of the technical solution, the soaking time of the NaₘPₙ solid in the electrolyte ranges from 12 hours to 30 hours;

As a further improvement of the technical solution, the soaking time of the NaₘPₙ solid in the electrolyte ranges from 20 hours to 24 hours.

As a further improvement of the technical solution, the amount of the NaₘPₙ solid soaked in the electrolyte ranges from 0.2 g/L to 10.0 g/L;

As a further improvement of the technical solution, the amount of the NaₘPₙ solid soaked in the electrolyte ranges from 1.0 g/L to 5.0 g/L;

As a further improvement of the technical solution, the amount of the NaₘPₙ solid soaked in the electrolyte ranges from 1.2 g/L to 3.0 g/L.

As a further improvement of the technical solution, the phosphorus-containing substance includes the KₚP_{q}; the preparation method and application method of the KₚP_{q} serving as the additive include:

adding the red phosphorus to the K-biphenyl solution, and stirring the solution at a certain temperature to obtain the KₚP_{q} solid by centrifuging and evaporating the solvent to dryness; and adding the electrolyte salt to the electrolyte solvent and dissolving the electrolyte salt, and then soaking and dissolving the KₚP_{q} solid in the electrolyte solvent to obtain the electrolyte with the KₚP_{q} dissolved. Wherein, the optional solvent of K-biphenyl solution is one or more of the tetrahydrofuran, the dimethoxyethane, the tetraethylene glycol dimethyl ether and the diglyme.

As a further improvement of the technical solution, the additive is added to the electrolyte in the inert gas atmosphere, such as the argon atmosphere.

As a further improvement of the technical solution, the solvent of K-biphenyl solution is selected from the tetrahydrofuran or the dimethoxyethane.

As a further improvement of the technical solution, the concentration of the K-biphenyl solution ranges from 0.2 mol/L to 2.0 mol/L;

As a further improvement of the technical solution, the concentration of the K-biphenyl solution ranges from 0.8 mol/L to 1.2 mol/L;

As a further improvement of the technical solution, the concentration of the K-biphenyl solution ranges from 1.0 mol/L to 1.1 mol/L;

As a further improvement of the technical solution, the molar ratio of the amount of the red phosphorus added to the K-biphenyl solution to K ranges from 1:3 to 11:1;

As a further improvement of the technical solution, the molar ratio of the amount of the red phosphorus added to the K-biphenyl solution to K ranges from 1:3 to 5:1;

As a further improvement of the technical solution, the molar ratio of the amount of the red phosphorus added to the K-biphenyl solution to K ranges from 1:3 to 7:3.

As a further improvement of the technical solution, a stirring time of the K-biphenyl solution with the red phosphorus added ranges from 2 hours to 30 hours;

As a further improvement of the technical solution, the stirring time of the K-biphenyl solution with the red phosphorus added ranges from 6 hours to 15 hours;

As a further improvement of the technical solution, the stirring time of the K-biphenyl solution with the red phosphorus added ranges from 10 hours to 12 hours.

As a further improvement of the technical solution, a stirring condition of the K-biphenyl solution with the red phosphorus added ranges from 25° C. to 40° C.; and

As a further improvement of the technical solution, the stirring condition of the K-biphenyl solution with the red phosphorus added ranges from 25° C. to 35° C.

As a further improvement of the technical solution, soaking time of the KₚP_{q} solid in the electrolyte ranges from 6 hours to 48 hours;

As a further improvement of the technical solution, the soaking time of the KₚP_{q} solid in the electrolyte ranges from 12 hours to 30 hours;

As a further improvement of the technical solution, the soaking time of the KₚP_{q} solid in the electrolyte ranges from 20 hours to 24 hours.

As a further improvement of the technical solution, the amount of the KₚP_{q} solid soaked in the electrolyte ranges from 0.2 g/L to 10.0 g/L;

As a further improvement of the technical solution, the amount of the KₚP_{q} solid soaked in the electrolyte ranges from 1.0 g/L to 5.0 g/L;

As a further improvement of the technical solution, the amount of the KₚP_{q} solid soaked in the electrolyte ranges from 1.2 g/L to 3.0 g/L.

In order to solve the other problem of the present application, the present application adopts the following technical solutions:

A preparation method of a phosphide is provided, the phosphide is LiₓP_{y}, where 0<x≤3 and 0<y≤11, and the specific preparation method includes:

adding red phosphorus to a Li-biphenyl solution, and stirring the solution at a certain temperature to obtain a LiₓP_{y} solid by centrifuging and evaporating the solvent to dryness. Wherein, the optional solvent of the Li-biphenyl solution is one or more of the tetrahydrofuran, the dimethoxyethane, the tetraethylene glycol dimethyl ether and the diglyme.

As a further improvement of the technical solution, the solvent of the Li-biphenyl solution is selected from the tetrahydrofuran or the dimethoxyethane.

As a further improvement of the technical solution, the concentration of the Li-biphenyl solution ranges from 0.2 mol/L to 2.0 mol/L;

As a further improvement of the technical solution, the concentration of the Li-biphenyl solution ranges from 0.8 mol/L to 1.2 mol/L;

As a further improvement of the technical solution, the concentration of the Li-biphenyl solution ranges from 1.0 mol/L to 1.1 mol/L;

As a further improvement of the technical solution, a molar ratio of the amount of the red phosphorus added to the Li-biphenyl solution to Li-biphenyl ranges from 1:3 to 11:1;

As a further improvement of the technical solution, the molar ratio of the amount of the red phosphorus added to the Li-biphenyl solution to Li ranges from 1:3 to 5:1;

As a further improvement of the technical solution, the molar ratio of the amount of the red phosphorus added to the Li-biphenyl solution to Li ranges from 1:3 to 7:3;

As a further improvement of the technical solution, the stirring time of the Li-biphenyl solution with the red phosphorus added ranges from 2 hours to 30 hours.

As a further improvement of the technical solution, the stirring time of the Li-biphenyl solution with the red phosphorus added ranges from 6 hours to 15 hours;

As a further improvement of the technical solution, the stirring time of the Li-biphenyl solution with the red phosphorus added ranges from 10 hours to 12 hours;

As a further improvement of the technical solution, a stirring condition of the Li-biphenyl solution with the red phosphorus added ranges from 25° C. to 40° C.;

As a further improvement of the technical solution, the stirring condition of the Li-biphenyl solution with the red phosphorus added ranges from 25° C. to 35° C.

A preparation method of a phosphide is provided, the phosphide is NaₘPₙ, where 0<m≤3 and 0<n≤11, and the specific preparation method includes:

adding red phosphorus to a Na-biphenyl solution, and stirring the solution at a certain temperature to obtain a NaₘPₙ solid by centrifuging and evaporating the solvent to dryness. Wherein, the optional solvent of the Na-biphenyl solution is one or more of the tetrahydrofuran, the dimethoxyethane, the tetraethylene glycol dimethyl ether and the diglyme.

As a further improvement of the technical solution, the solvent of the Na-biphenyl solution is selected from the tetrahydrofuran or the dimethoxyethane.

As a further improvement of the technical solution, the concentration of the Na-biphenyl solution ranges from 0.2 mol/L to 2.0 mol/L;

As a further improvement of the technical solution, the concentration of the Na-biphenyl solution ranges from 0.8 mol/L to 1.2 mol/L;

As a further improvement of the technical solution, the concentration of the Na-biphenyl solution ranges from 1.0 mol/L to 1.1 mol/L;

As a further improvement of the technical solution, the molar ratio of the amount of the red phosphorus added to the Na-biphenyl solution to Na ranges from 1:3 to 11:1;

As a further improvement of the technical solution, the molar ratio of the amount of the red phosphorus added to the Na-biphenyl solution to Na ranges from 1:3 to 5:1;

As a further improvement of the technical solution, the molar ratio of the amount of the red phosphorus added to the Na-biphenyl solution to Na ranges from 1:3 to 7:3;

As a further improvement of the technical solution, the stirring time of the Na-biphenyl solution with the red phosphorus added ranges from 2 hours to 30 hours;

As a further improvement of the technical solution, the stirring time of the Na-biphenyl solution with the red phosphorus added ranges from 6 hours to 15 hours;

As a further improvement of the technical solution, the stirring time of the Na-biphenyl solution with the red phosphorus added ranges from 10 hours to 12 hours;

As a further improvement of the technical solution, the stirring condition of the Na-biphenyl solution with the red phosphorus added ranges from 25° C. to 40° C.; and

As a further improvement of the technical solution, the stirring condition of the Na-biphenyl solution with the red phosphorus added ranges from 25° C. to 35° C.;

A preparation method of a phosphide is provided, the phosphide is KₚP_{q}, where 0<p≤3 and 0<q≤11, and the specific preparation method includes:

adding red phosphorus to a K-biphenyl solution, and stirring the solution at a certain temperature to obtain a KₚP_{q} solid by centrifuging and evaporating the solvent to dryness. Wherein, the optional solvent of K-biphenyl solution is one or more of the tetrahydrofuran, the dimethoxyethane, the tetraethylene glycol dimethyl ether and the diglyme.

As a further improvement of the technical solution, the solvent of the K-biphenyl solution is selected from the tetrahydrofuran or the dimethoxyethane.

As a further improvement of the technical solution, the concentration of the K-biphenyl solution ranges from 0.2 mol/L to 2.0 mol/L;

As a further improvement of the technical solution, the concentration of the K-biphenyl solution ranges from 0.8 mol/L to 1.2 mol/L;

As a further improvement of the technical solution, the concentration of the K-biphenyl solution ranges from 1.0 mol/L to 1.1 mol/L;

As a further improvement of the technical solution, the molar ratio of the amount of the red phosphorus added to the K-biphenyl solution to K ranges from 1:3 to 11:1;

As a further improvement of the technical solution, the molar ratio of the amount of the red phosphorus added to the K-biphenyl solution to K ranges from 1:3 to 5:1;

As a further improvement of the technical solution, the molar ratio of the amount of the red phosphorus added to the K-biphenyl solution to K ranges from 1:3 to 7:3.

As a further improvement of the technical solution, the stirring time of the K-biphenyl solution with the red phosphorus added ranges from 2 hours to 30 hours.

As a further improvement of the technical solution, the stirring time of the K-biphenyl solution with the red phosphorus added ranges from 6 hours to 15 hours;

As a further improvement of the technical solution, the stirring time of the K-biphenyl solution with the red phosphorus added ranges from 10 hours to 12 hours;

As a further improvement of the technical solution, the stirring condition of the K-biphenyl solution with the red phosphorus added ranges from 25° C. to 40° C.

As a further improvement of the technical solution, the stirring condition of the K-biphenyl solution with the red phosphorus added ranges from 25° C. to 35° C.

In order to solve the other problem of the present application, the present application adopts the following technical solutions:

An electrolyte applied to a secondary battery is provided, and the electrolyte includes an electrolyte salt, an organic solvent and the above-mentioned capacity-compensation electrolyte additive.

As a further improvement of the technical solutions, the organic solvent includes one or more of an ester solvent, an ether solvent, a sulfone solvent and a nitrile solvent;

as a further improvement of the technical solutions, the ester solvent is selected from one or more of ethylene carbonate (EC), diethyl carbonate (DEC), dimethyl carbonate (DMC), ethyl methyl carbonate (EMC), propylene carbonate (PC), chlorocarbonate (Cl MC), ethyl propionate (EP) and propyl propionate (PP);

As a further improvement of the technical solution, the ether solvent is selected from one or more of dimethoxyethane (DME), 1,3-dioxolame (1,3-DOL) and diglyme (DG);

as a further improvement of the technical solutions, the sulfone solvent is selected from one or more of sulfolane (SL) and dimethyl sulfoxide (DMSO); and

as a further improvement of the technical solutions, the nitrile solvent is selected from one or more of acetonitrile (AN), succinonitrile (SN) and hexanedinitrile (HN).

As a further improvement of the technical solution, the ester solvent is selected from a combination of EC/DEC, EC/EMC and EC/EMC/DMC, and an adaptive additive is selected from one or more of LiP₅, LiP₇, NaP₅, NaP₇, KP₅ and K₃P₇;

As a further improvement of the technical solution, the ether solvent is selected from a combination of DME/1,3-DOL, and the adaptive additive is selected from one or more of LiP₅, LiP₇, NaP₅, NaP₇, KP₅ and K₃P₇;

As a further improvement of the technical solution, the sulfone solvent is selected from DMSO, and the adaptive additive is selected from one or more of LiP₅, LiP₇, NaP₅, NaP₇, KP₅ and K₃P₇;

As a further improvement of the technical solution, the nitrile solvent is selected from AN or SN, and the adaptive additive is selected from one or more of LiP₅, LiP₇, NaP₅, NaP₇, KP₅ and K₃P₇.

As a further improvement of the technical solution, in the electrolyte salt, the electrolyte of the lithium-ion battery includes one or a combination of more of lithium hexafluorophosphate (LiPF₆), lithium tetrafluoroborate (LiBF₄), lithium perchlorate (LiClO₄), lithium hexafluoroarsenate (LiAsF₆), lithium bis(oxalate)borate (LiBOB), lithium difluoro(oxalato)borate (LiDFOB), lithium bis(fluorosulfonyl)imide (LiFSI), lithium bis(trifluoromethanesulfonyl)imide (LiTFSI), lithium trifluoromethanesulfonate (LiCF₃SO₃), lithium bis(trifluoromethylsulfonyl)imide (LiN(CF₃SO₂)₂) and lithium tetrafluorooxalate phosphate (LiPF₄(C₂O₄)).

As a further improvement of the technical solution, the electrolyte salt of the sodium-ion battery includes NaClO₄ and/or NaPF₆.

As a further improvement of the technical solution, the electrolyte salt of the potassium-ion battery includes one or more of potassium hexafluorophosphate (KPF₆), potassium bis(trifluoromethanesulfonly)imide (KTFSI) and potassium bis(fluorosulfonyl)imide (KFSI).

As a further improvement of the technical solution, in the ester solvent, the electrolyte is the LiPF₆, the NaClO₄ or the KPF₆;

As a further improvement of the technical solution, in the ether solvent, the electrolyte is the LiFSI, the LiTFSI, the NaPF₆ or the KTFSI;

As a further improvement of the technical solution, in the sulfone solvent, the electrolyte is the LiTFSI; and

As a further improvement of the technical solution, in the nitrile solvent, the electrolyte is the LiFSI.

As a further improvement of the technical solution, a mass percentage of the electrolyte additive dissolved in the electrolyte ranges from 0.1% to 25%.

As a further improvement of the technical solutions, a mass percent of the electrolyte additive dissolved in the electrolyte ranges from 8%-12%.

As a further improvement of the technical solution, most preferably, the mass percentage of the electrolyte additive dissolved in the electrolyte is 10%.

In order to solve the other problem of the present application, the present application adopts the following technical solutions:

A preparation method of the electrolyte for the secondary battery is provided, the electrolyte includes an electrolyte salt, an organic solvent and the electrolyte additive LiₓP_{y}, where 0<x≤3 and 0<y≤11, and the preparation method of the electrolyte includes:

adding the red phosphorus to the Li-biphenyl solution, and stirring the solution at a certain temperature to obtain the LiₓP_{y} solid by centrifuging and evaporating the solvent to dryness; adding the electrolyte salt to the electrolyte solvent and dissolving the electrolyte salt, and then soaking and dissolving the LiₓP_{y} solid in the electrolyte solvent to obtain the electrolyte with the LiₓP_{y} dissolved. Wherein, the optional solvent of the Li-biphenyl solution is one or more of the tetrahydrofuran, the dimethoxyethane, the tetraethylene glycol dimethyl ether and the diglyme.

As a further improvement of the technical solution, the additive is added to the electrolyte in the inert gas atmosphere, such as the argon atmosphere.

As a further improvement of the technical solution, the solvent of the Li-biphenyl solution is selected from the tetrahydrofuran or the dimethoxyethane.

As a further improvement of the technical solution, the concentration of the Li-biphenyl solution ranges from 0.2 mol/L to 2.0 mol/L;

As a further improvement of the technical solution, the concentration of the Li-biphenyl solution ranges from 0.8 mol/L to 1.2 mol/L;

As a further improvement of the technical solution, the concentration of the Li-biphenyl solution ranges from 1.0 mol/L to 1.1 mol/L;

As a further improvement of the technical solution, the molar ratio of the amount of the red phosphorus added to the Li-biphenyl solution to Li ranges from 1:3 to 11:1;

As a further improvement of the technical solution, the molar ratio of the amount of the red phosphorus added to the Li-biphenyl solution to Li ranges from 1:3 to 5:1;

As a further improvement of the technical solution, the molar ratio of the amount of the red phosphorus added to the Li-biphenyl solution to Li ranges from 1:3 to 7:3;

As a further improvement of the technical solution, the stirring time of the Li-biphenyl solution with the red phosphorus added ranges from 2 hours to 30 hours.

As a further improvement of the technical solution, the stirring time of the Li-biphenyl solution with the red phosphorus added ranges from 6 hours to 15 hours;

As a further improvement of the technical solution, the stirring time of the Li-biphenyl solution with the red phosphorus added ranges from 10 hours to 12 hours;

As a further improvement of the technical solution, the stirring condition of the Li-biphenyl solution with the red phosphorus added ranges from 25° C. to 40° C.

As a further improvement of the technical solution, the stirring condition of the Li-biphenyl solution with the red phosphorus added ranges from 25° C. to 35° C.

As a further improvement of the technical solution, the soaking time of the LiₓP_{y} solid in the electrolyte ranges from 6 hours to 48 hours;

As a further improvement of the technical solution, the soaking time of the LiₓP_{y} solid in the electrolyte ranges from 12 hours to 30 hours;

As a further improvement of the technical solution, the soaking time of the LiₓP_{y} solid in the electrolyte ranges from 20 hours to 24 hours;

As a further improvement of the technical solution, the amount of the LiₓP_{y} solid soaked in the electrolyte ranges from 1.0 g/L to 10.0 g/L.

As a further improvement of the technical solution, the amount of the LiₓP_{y} solid soaked in the electrolyte ranges from 1.0 g/L to 5.0 g/L;

As a further improvement of the technical solution, the amount of the LiₓP_{y} solid soaked in the electrolyte ranges from 1.2 g/L to 3.0 g/L.

A preparation method of the electrolyte for the secondary battery is provided, the electrolyte includes an electrolyte salt, an organic solvent and the electrolyte additive NaₘPₙ, where 0<m≤3 and 0<n≤11, and the preparation method of the electrolyte includes:

adding the red phosphorus to the Na-biphenyl solution, and stirring the solution at a certain temperature to obtain the NaₘPₙ solid by centrifuging and evaporating the solvent to dryness; and adding the electrolyte salt to the electrolyte solvent and dissolving the electrolyte salt, and then soaking and dissolving the NaₘPₙ solid in the electrolyte solvent to obtain the electrolyte with the NaₘPₙ dissolved. Wherein, the optional solvent of the Na-biphenyl solution is one or more of the tetrahydrofuran, the dimethoxyethane, the tetraethylene glycol dimethyl ether and the diglyme.

As a further improvement of the technical solution, the additive is added to the electrolyte in the inert gas atmosphere, such as the argon atmosphere.

As a further improvement of the technical solution, the solvent of the Na-biphenyl solution is selected from the tetrahydrofuran or the dimethoxyethane.

As a further improvement of the technical solution, the concentration of the Na-biphenyl solution ranges from 0.2 mol/L to 2.0 mol/L;

As a further improvement of the technical solution, the concentration of the Na-biphenyl solution ranges from 0.8 mol/L to 1.2 mol/L;

As a further improvement of the technical solution, the concentration of the Na-biphenyl solution ranges from 1.0 mol/L to 1.1 mol/L;

As a further improvement of the technical solution, the molar ratio of the amount of the red phosphorus added to the Na-biphenyl solution to Na ranges from 1:3 to 11:1;

As a further improvement of the technical solution, the molar ratio of the amount of the red phosphorus added to the Na-biphenyl solution to Na ranges from 1:3 to 5:1;

As a further improvement of the technical solution, the molar ratio of the amount of the red phosphorus added to the Na-biphenyl solution to Na ranges from 1:3 to 7:3;

As a further improvement of the technical solution, the stirring time of the Na-biphenyl solution with the red phosphorus added ranges from 2 hours to 30 hours;

As a further improvement of the technical solution, the stirring time of the Na-biphenyl solution with the red phosphorus added ranges from 6 hours to 15 hours;

As a further improvement of the technical solution, the stirring time of the Na-biphenyl solution with the red phosphorus added ranges from 10 hours to 12 hours;

As a further improvement of the technical solution, the stirring condition of the Na-biphenyl solution with the red phosphorus added ranges from 25° C. to 40° C.;

As a further improvement of the technical solution, the stirring condition of the Na-biphenyl solution with the red phosphorus added ranges from 25° C. to 35° C.;

As a further improvement of the technical solution, the soaking time of the NaₘPₙ solid in the electrolyte ranges from 6 hours to 48 hours;

As a further improvement of the technical solution, the soaking time of the NaₘPₙ solid in the electrolyte ranges from 12 hours to 30 hours;

As a further improvement of the technical solution, the soaking time of the NaₘPₙ solid in the electrolyte ranges from 20 hours to 24 hours.

As a further improvement of the technical solution, the amount of the NaₘPₙ solid soaked in the electrolyte ranges from 0.2 g/L to 10.0 g/L;

As a further improvement of the technical solution, the amount of the NaₘPₙ solid soaked in the electrolyte ranges from 1.0 g/L to 5.0 g/L;

As a further improvement of the technical solution, the amount of the NaₘPₙ solid soaked in the electrolyte ranges from 1.2 g/L to 3.0 g/L;

A preparation method of the electrolyte for the secondary battery is provided, the electrolyte includes an electrolyte salt, an organic solvent and the electrolyte additive KₚP_{q}, where 0<p≤3 and 0<q≤11, and the preparation method of the electrolyte includes:

adding the red phosphorus to the K-biphenyl solution, and stirring the solution at a certain temperature to obtain the KₚP_{q} solid by centrifuging and evaporating the solvent to dryness; and adding the electrolyte salt to the electrolyte solvent and dissolving the electrolyte salt, and then soaking and dissolving the KₚP_{q} solid in the electrolyte solvent to obtain the electrolyte with the KₚP_{q} dissolved. Wherein, the optional solvent of K-biphenyl solution is one or more of the tetrahydrofuran, the dimethoxyethane, the tetraethylene glycol dimethyl ether and the diglyme.

As a further improvement of the technical solution, the additive is added to the electrolyte in the inert gas atmosphere, such as the argon atmosphere.

As a further improvement of the technical solution, the solvent of the K-biphenyl solution is selected from the tetrahydrofuran or the dimethoxyethane.

As a further improvement of the technical solution, the concentration of the K-biphenyl solution ranges from 0.2 mol/L to 2.0 mol/L;

As a further improvement of the technical solution, the concentration of the K-biphenyl solution ranges from 0.8 mol/L to 1.2 mol/L;

As a further improvement of the technical solution, the concentration of the K-biphenyl solution ranges from 1.0 mol/L to 1.1 mol/L:

As a further improvement of the technical solution, the molar ratio of the amount of the red phosphorus added to the K-biphenyl solution to K ranges from 1:3 to 11:1;

As a further improvement of the technical solution, the molar ratio of the amount of the red phosphorus added to the K-biphenyl solution to K ranges from 1:3 to 5:1;

As a further improvement of the technical solution, the molar ratio of the amount of the red phosphorus added to the K-biphenyl solution to K ranges from 1:3 to 7:3.

As a further improvement of the technical solution, the stirring time of the K-biphenyl solution with the red phosphorus added ranges from 2 hours to 30 hours.

As a further improvement of the technical solution, the stirring time of the K-biphenyl solution with the red phosphorus added ranges from 6 hours to 15 hours;

As a further improvement of the technical solution, the stirring time of the K-biphenyl solution with the red phosphorus added ranges from 10 hours to 12 hours;

As a further improvement of the technical solution, the stirring condition of the K-biphenyl solution with the red phosphorus added ranges from 25° C. to 40° C.

As a further improvement of the technical solution, the stirring condition of the K-biphenyl solution with the red phosphorus added ranges from 25° C. to 35° C.

As a further improvement of the technical solution, the soaking time of the KₚP_{q} solid in the electrolyte ranges from 6 hours to 48 hours;

As a further improvement of the technical solution, the soaking time of the KₚP_{q} solid in the electrolyte ranges from 12 hours to 30 hours;

As a further improvement of the technical solution, the soaking time of the KₚP_{q} solid in the electrolyte ranges from 20 hours to 24 hours;

As a further improvement of the technical solution, the amount of the KₚP_{q} solid soaked in the electrolyte ranges from 0.2 g/L to 10.0 g/L;

As a further improvement of the technical solution, the amount of the KₚP_{q} solid soaked in the electrolyte ranges from 1.0 g/L to 5.0 g/L;

As a further improvement of the technical solution, the amount of the KₚP_{q} solid soaked in the electrolyte ranges from 1.2 g/L to 3.0 g/L;

In order to solve the other problem of the present application, the present application adopts the following technical solutions:

A secondary ion battery includes a cathode, an anode, a separator and the above-mentioned electrolyte.

As a further improvement of the technical solutions, the secondary ion battery includes a lithium-ion battery, a sodium-ion battery or a potassium-ion battery;

as a further improvement of the technical solutions, the cathode of the lithium-ion battery is selected from one or more of LiCoO₂, LiNiO₂, LiMn₂O₄, LiNi_{0.5}Mn_{1.5}O₄, Li₃V₂(PO₄)₃, LiFePO₄, LiNiₐCo_{b}Mn_{1-a-b}O₂, LiNi_{c}Co_{d}Al_{1-c-d}O₂ and S, where 0<a, b, c, d<1; and

As a further improvement of the technical solution, the cathode of the sodium-ion battery is selected from one or more of sodium cobaltate, sodium manganate, sodium nickelate, sodium vanadate, sodium manganese phosphate, sodium iron phosphate, sodium vanadium phosphate, nickel-iron sodium manganate and sodium-rich sodium manganate; and

As a further improvement of the technical solution, the cathode of the potassium-ion battery is selected from one or more of a Prussian blue analogue containing potassium, KMO₂, K₃V₂(PO₄)₂F₃, KVOPO₄, KVPO₄F, K₄Fe₃(PO₄)₂(P₂O₇) and KFeC₂O₄, where M in the KMO₂ is a transition metal.

As a further improvement of the technical solution, the anode is selected from one or more of artificial graphite, natural graphite, a carbon-based anode, a carbon nanotube, silicon and alloys thereof, tin and alloys thereof, germanium and alloys thereof, a phosphorus-based anode, a lithium metal, Li₄T₁₅O₁₂ and a transition metal compound MᵢXₖ, where M is a metal element, X is selected from O, S, F or N, 0<i<3, and 0<k<4.

As a further improvement of the technical solutions, MᵢXₖ is selected from Fe₂O₃, Co₃O₄, MoS₂ or SnO₂.

As a further improvement of the technical solution, a cathode/anode system is LiNi_{0.5}Co_{0.2}Mn_{0.3}O₂/red phosphorus-CNT, LiNi_{0.5}Co_{0.2}Mn_{0.3}O₂/nano-silicon, LiNi_{0.8}Co_{0.1}Mn_{0.1}O₂/graphite, LiCoO₂/SnO₂, LiMn₂O₄/Li metal, LiFePO₄/graphite, LiFePO₄/MoS₂, NaV₆O₁₅/black phosphorus-graphite complex or potassium-containing Prussian blue/graphite.

By adopting the above technical solutions, the present disclosure can achieve the following beneficial effects: in this method, capacity compensation is conducted by adding the additive to the electrolyte, not only can the lithium/sodium/potassium ions be released through decomposition in the first charging cycle to compensate the loss of the active ions in the first cycle and improve the initial Coulombic efficiency of the battery, but also the capacity compensation can be conducted by releasing lithium/sodium/potassium ions through decomposition when dead lithium/sodium/potassium is generated in the cycling process of the anode (such as phosphorus and silicon) of an alloying reaction mechanism with a high specific capacity and the anode (such as a transition metal oxide anode) of a conversion reaction mechanism; the additive is dispersed in the electrolyte, which is conducive to formation of a relatively uniform SEI on the anode; during application to high-nickel cathode materials, the LiₓP_{y} can coordinate with Ni to inhibit Li/Ni cation mixing, and facilitate formation of uniform and stable cathode electrolyte interphase (CEI), thereby improving the cycle stability of the cathode materials; and a P simple substance generated after delithiation can serve as flame retardants, and therefore the safety performance of the battery is improved. The method is simple and easy to implement, and can be compatible with existing production equipment.

Any range as recorded by the present disclosure is intended to include end values and any value between end values and any sub-range subsumed or defined therein.

### BRIEF DESCRIPTION OF THE DRAWINGS

FIG. 1 is a mass spectrum of a product formed by adding red phosphorus to a 1.0 mol/L tetrahydrofuran solution of Li-biphenyl (a molar ratio of the red phosphorus to Li-biphenyl is 3:1), stirring the solution at 25° C. for 12 hours and centrifuging to obtain a LiₓP_{y} solid, and then soaking the LiₓP_{y} solid in EC:DEC=1:1 (v:v) for dissolving.

FIG. 2 illustrates first-cycle charge-discharge curves of batteries in Embodiment 1 and Comparative Example 1.

FIG. 3 illustrates cycle-specific capacity curves of the batteries in Embodiment 1 and Comparative Example 1.

FIG. 4 illustrates first-cycle charge-discharge curves of batteries in Embodiment 6 and Comparative Example 2.

FIG. 5 illustrates cycle-specific capacity curves of the batteries in Embodiment 6 and Comparative Example 2.

### DETAILED DESCRIPTION OF THE PRESENT DISCLOSURE

Specific implementations of the present disclosure will be described below. Apparently, the described embodiments are only a part of embodiments of the present disclosure rather than all embodiments. All other embodiments obtained by those ordinarily skilled in the art without involving inventive effort based on the embodiments in the present disclosure fall within the protection scope of the present disclosure.

The present application provides a capacity-compensation electrolyte additive, including one or a combination of more of LiₓP_{y}, NaₘPₙ and KₚP_{q}, where 0<x≤3, 0<y≤11, 0<m≤3, 0<n≤11, 0<p≤3, and 0<q≤11. The additive may be dissolved in an electrolyte and applied to a secondary battery. The additive may decompose prior to an electrolyte solvent and an electrolyte salt to release the active ions for compensating the capacity loss occurred in the first cycle and subsequent cycle processes of the battery, and therefore the cycle stability and energy density of the batter are improved.

According to some implementations of the present application, the secondary battery includes a lithium-ion battery, a sodium-ion battery or a potassium-ion battery.

According to some implementations of the present application, in the lithium-ion battery, the additive is preferably LiₓP_{y}, and preferably, 1≤x<3, and 4≤y≤10; and the LiₓP_{y} is preferably LiP₄, LiP₅, LiP₇, LiP₈ or LiP₁₀, and most preferably, LiP₅ or LiP₇;

According to some implementations of the present application, in the sodium-ion battery, the additive is preferably NaₘPₙ, and preferably, 1≤m<3, and 4≤n≤10; and the NaₘPₙ is preferably NaP₄, NaP₅, NaP₇ or NaP₁₀, and most preferably, NaP₅ or NaP₇; and

According to some implementations of the present application, in the potassium-ion battery, the additive is preferably KₚP_{q}, and preferably, 1≤p≤3, and 4≤q≤10; and the KₚP_{q} is preferably KP₄, KP₅, KP₇ or K₃P₇, and most preferably, KP₅ or K₃P₇.

Electrolyte lithium compensating additives in the prior art have the defects of poor compatibility with the electrolyte solvents. Researches on lithium polyphosphide mostly remain in these common lithium polyphosphide compounds such as Li₃P and Li₅P, which are mostly used to compensate lithium in electrodes or to modify lithium metal surfaces. The applicant of the present disclosure tried to add these substances to the electrolyte, and it was verified by a large number of experiments that these conventional lithium polyphosphate solids show poor solubility in widely used electrolyte solvents, and are unsuitable for serving as electrolyte lithium-compensating additives.

After long-term creative work, the applicant of the present disclosure developed a new polyphosphide preparation method. By this method, LiP₄, LiP₅, LiP₇, LiP₈ and LiP₁₀, especially LiP₅ and LiP₇ could be prepared, and it was verified by a large number of experiments that these lithium polyphosphates could be dissolved in common ester, ether, sulfone or nitrile organic solvents which could serve as the electrolyte solvents. Meanwhile, the applicant also found that when these lithium polyphosphates which could be dissolved in the electrolyte solvents were added to the electrolyte, the lithium polyphosphates could decompose prior to the electrolyte solvents on the surface of an electrode, achieving an excellent effect of compensating lithium and electrons. Therefore, capacity loss caused by formation of the SEI in a battery cycling process and generation of dead lithium in the subsequent cycling process could be compensated.

In a sodium-ion battery, the applicant of the present disclosure developed sodium polyphosphates (such as NaP₄, NaP₅, NaP₇ and NaP₁₀) which could be dissolved in the electrolyte solvents, and added to the electrolyte as the additive, and the sodium polyphosphates could also decompose prior to the solvents in the electrolyte, achieving the effect of compensating the sodium and the electrons. Therefore, capacity loss caused by formation of the SEI in the battery cycling process and generation of dead sodium in the subsequent cycling process could be compensated.

In a potassium-ion battery, the applicant of the present disclosure developed potassium polyphosphates (such as KP₄, KP₅, KP₇ and K₃P₇) which could be dissolved in the electrolyte solvents, and added them to the electrolyte as the additive, and the potassium polyphosphates could also decompose prior to the solvents in the electrolyte, achieving the effect of compensating the potassium and the electrons. Therefore, capacity loss caused by formation of the SEI in the battery cycling process and generation of dead potassium in the subsequent cycling process could be compensated. These achievements and technical solutions are discovered and reported by the applicant for the first time.

The above additives are higher in solubility in the common electrolyte solvents, and have a lower LUMO energy level and a higher HOMO energy level. The additive is decomposed on an anode side prior to the electrolyte solvents due to the LUMO energy level lower than that of the electrolyte solvents, so that stable SEI is preferentially formed on the surface of the anode. The additive is decomposed on a cathode side prior to the electrolyte solvents due to the HOMO energy level higher than that of the electrolyte solvents, so that stable CEI is preferentially formed on the surface of the cathode. Thus, the additive can improve the stability of an electrode-electrolyte interface in the battery and improve the cycle property of the battery.

The present application further provides a preparation method of the above-mentioned electrolyte additive. The additive includes one or more of the LiₓP_{y}, the NaₘPₙ and the KₚP_{q}, and the method includes the step that a certain amount of red phosphorus is added to a Li-biphenyl solution, a Na-biphenyl solution or a K-biphenyl solution, and stirred at a certain temperature to obtain a LiₓP_{y} solid, a NaₘPₙ solid or a KₚP_{q} solid by centrifuging and evaporating the solvent to dryness.

In the prior art, there was no report on preparation of the LiₓP_{y}, NaₘPₙ and KₚP_{q} solids by adopting the above method. The applicant firstly adopted mild liquid-solid reactions, namely reactions between Li-biphenyl and red phosphorus, between Na-biphenyl and red phosphorus, and between K-biphenyl and red phosphorus, to prepare the LiₓP_{y}, NaₘPₙ and KₚP_{q} solids respectively. In this method, different lithium, sodium, potassium and phosphorus compounds could be prepared by regulating the proportions of the Li-biphenyl, the Na-biphenyl and the K-biphenyl to the red phosphorus, and high-temperature heating can be avoided. The prepared phosphorus-containing compound was soaked in the electrolyte, and soluble components could be dissolved in the electrolyte as capacity compensation additives, which played a role in compensating active ions and electrons.

The present application further provides application of a phosphorus-containing substance as an electrolyte additive. The phosphorus-containing substance includes one or a combination of more of LiₓP_{y}, NaₘPₙ and KₚP_{q}, and the phosphorus-containing substance is dissolved in the electrolyte;

Where, 0<x≤3, 0<y≤11, 0<m≤3, 0<n≤11, 0<p≤3 and 0<q≤11.

The application of the present disclosure includes the step that one or more of the LiₓP_{y}, the NaₘPₙ and the KₚP_{q} is soaked in the electrolyte solvent for dissolving to obtain the electrolyte containing the additive. In order to solve the problems of damage of lithium supplement in an electrode to an electrode plate structure and low compatibility of some existing electrolyte lithium-compensating additives in the electrolyte solvent, the applicant firstly proposed that soluble polyphosphides were dissolved in the electrolyte as lithium/sodium/potassium-compensating additives, and the additives could be compatible with common electrolyte solvents, electrolyte salts and cathode/anode systems, which can not only play a role in releasing the active ions through decomposition, but can also stabilize the electrode interface and improve the cycle stability of the battery. The effects of the polyphosphides will be further validated in embodiments in combination with test data.

According to some implementations of the present application, the phosphorus-containing substance includes the LiₓP_{y}; and the application of the LiₓP_{y} serving as the additive includes:

red phosphorus is added to a Li-biphenyl solution, and stirred at a certain temperature to obtain a LiₓP_{y} solid by centrifuging and evaporating the solvent to dryness; and an electrolyte salt is added to the electrolyte solvent for dissolving, and then the LiₓP_{y} solid is soaked in the electrolyte solvent for dissolving to obtain the electrolyte with the LiₓP_{y} dissolved. Wherein, the optional solvent of the Li-biphenyl solution is one or more of the tetrahydrofuran, the dimethoxyethane, the tetraethylene glycol dimethyl ether and the diglyme.

According to some implementations of the present application, the additive is added to the electrolyte in the inert gas atmosphere, such as the argon atmosphere. It is the same as common liquid injection environment, and additional steps are not required in industrial production.

According to some implementations of the present application, the solvent of the Li-biphenyl solution is selected from the tetrahydrofuran and the dimethoxyethane. As the boiling points of the two solvents are lower, the solvents are easy to evaporate after synthesis to obtain the pure LiₓP_{y}.

According to some implementations of the present application, the concentration of the Li-biphenyl solution is 0.2 mol/L to 2.0 mol/L. The concentration of the Li-biphenyl solution is preferably 0.8 mol/L to 1.2 mol/L, and the concentration of the Li-biphenyl solution is most preferably, 1.0 mol/L to 1.1 mol/L. In the preferred concentration of the Li-biphenyl solution, the yield of the obtained lithium polyphosphates is higher.

According to some implementations of the present application, the molar ratio of the amount of the red phosphorus added to the Li-biphenyl solution to Li is 1:5 to 11:1, preferably 1:3 to 5:1, and most preferably, 1:3 to 7:3. In the preferred range, the soluble product of the obtained lithium polyphosphates in the electrolyte is higher in solubility, and can achieve a better effect of capacity compensation.

According to some implementations of the present application, the stirring time of the Li-biphenyl solution with the red phosphorus added is 2 hours to 30 hours, preferably 6 hours to 15 hours, and most preferably, 10 hours to 12 hours. In the preferred time range, the red phosphorus and the Li-biphenyl can react fully to obtain an ideal reaction product.

According to some implementations of the present application, the stirring condition of the Li-biphenyl solution with the red phosphorus added is 25° C. to 40° C., and preferably 25° C. to 35° C. Under the above reaction conditions, the Li-biphenyl can react with the red phosphorus fully to obtain the product LiₓP_{y}.

According to some implementations of the present application, the soaking time of the LiₓP_{y} solid in the electrolyte is 6 hours to 48 hours, preferably 12 hours to 30 hours, and most preferably, 20 hours to 24 hours. Within the preferred soaking time, the LiₓP_{y} solid can be fully dissolved in the electrolyte solvent to reach a certain amount of addition.

According to some implementations of the present application, the amount of the LiₓP_{y} solid soaked in the electrolyte is 0.2 g/L to 10.0 g/L, preferably 1.0 g/L to 5.0 g/L, and most preferably, 1.2 g/L to 3.0 g/L. Under the above reaction conditions, the electrolyte with the LiₓP_{y} additive dissolved is obtained, and can reach a proper concentration.

According to some implementations of the present application, the phosphorus-containing substance includes the NaₘPₙ; and the application of the NaₘPₙ serving as the additive includes:

adding the red phosphorus to the Na-biphenyl solution, and stirring the solution at a certain temperature to obtain the NaₘPₙ solid by centrifuging and evaporating the solvent to dryness; and adding the electrolyte salt to the electrolyte solvent and dissolving the electrolyte salt, and then soaking and dissolving the NaₘPₙ solid in the electrolyte solvent to obtain the electrolyte with the NaₘPₙ dissolved. Wherein, the optional solvent of the Na-biphenyl solution is one or more of tetrahydrofuran, dimethoxyethane, tetraethylene glycol dimethyl ether and diglyme.

According to some implementations of the present application, the solvent of the Na-biphenyl solution is selected from the tetrahydrofuran and the dimethoxyethane. As the boiling points of the two solvents are lower, the solvents are easy to evaporate after synthesis to obtain the pure NaₘPₙ.

According to some implementations of the present application, the concentration of the Na-biphenyl solution is 0.2 mol/L to 2.0 mol/L. The concentration of the Na-biphenyl solution is preferably 0.8 mol/L to 1.2 mol/L, and the concentration of the Na-biphenyl solution is most preferably 1.0 mol/L to 1.1 mol/L. In the preferred concentration of the Na-biphenyl solution, the yield of the obtained sodium polyphosphates is higher.

According to some implementations of the present application, the molar ratio of the amount of the red phosphorus added to the Na-biphenyl solution to Na is 1:5 to 11:1, preferably 1:3 to 5:1, and most preferably, 1:3 to 7:3. In the preferred range, the soluble product of the obtained sodium polyphosphates in the electrolyte is higher in solubility, and can achieve a better effect of capacity compensation.

According to some implementations of the present application, the stirring time of the Na-biphenyl solution with the red phosphorus added is 2 hours to 30 hours, preferably 6 hours to 15 hours, and most preferably, 10 hours to 12 hours. In the preferred time range, the red phosphorus and the Na-biphenyl can react fully to obtain an ideal reaction product.

According to some implementations of the present application, the stirring condition of the Na-biphenyl solution with the red phosphorus added is 25° C. to 40° C., and preferably 25° C. to 35° C. Under the above reaction conditions, the Na-biphenyl can react with the red phosphorus fully to obtain the product NaₘPₙ.

According to some implementations of the present application, the soaking time of the NaₘPₙ solid in the electrolyte is 6 hours to 48 hours, preferably 12 hours to 30 hours, and most preferably, 20 hours to 24 hours. Within the preferred soaking time, the NaₘPₙ solid can be fully dissolved in the electrolyte solvent to reach a certain amount of addition.

According to some implementations of the present application, the amount of the NaₘPₙ solid soaked in the electrolyte is 0.2 g/L to 10.0 g/L, preferably 1.0 g/L to 5.0 g/L, and most preferably, 1.2 g/L to 3.0 g/L. Under the above reaction conditions, the electrolyte with the NaₘPₙ additive dissolved is obtained, and can reach a proper concentration.

According to some implementations of the present application, the phosphorus-containing substance includes the KₚP_{q}; and the application of the KₚP_{q} serving as the additive includes:

adding the red phosphorus to the K-biphenyl solution, and stirring the solution at a certain temperature to obtain the KₚP_{q} solid by centrifuging and evaporating the solvent to dryness; and adding the electrolyte salt to the electrolyte solvent and dissolving the electrolyte salt, and then soaking and dissolving the KₚP_{q} solid in the electrolyte solvent to obtain the electrolyte with the KₚP_{q} dissolved. Wherein, the optional solvent of K-biphenyl solution is one or more of the tetrahydrofuran, the dimethoxyethane, the tetraethylene glycol dimethyl ether and the diglyme.

According to some implementations of the present application, the solvent of K-biphenyl solution is selected from the tetrahydrofuran and the dimethoxyethane. As the boiling points of the two solvents are lower, the solvents are easy to evaporate after synthesis to obtain the pure KₚP_{q}.

According to some implementations of the present application, the concentration of the K-biphenyl solution is 0.2 mol/L to 2.0 mol/L. The concentration of the K-biphenyl solution is preferably 0.8 mol/L to 1.2 mol/L, and the concentration of the K-biphenyl solution is most preferably 1.0 mol/L to 1.1 mol/L. In the preferred concentration of the K-biphenyl solution, the yield of the obtained potassium polyphosphates is higher.

According to some implementations of the present application, the molar ratio of the amount of the red phosphorus added to the K-biphenyl solution to K is 1:5 to 11:1, preferably 1:3 to 5:1, and most preferably, 1:3 to 7:3. In the preferred range, the soluble product of the obtained potassium polyphosphates in the electrolyte is higher in solubility, and can achieve a better effect of capacity compensation.

According to some implementations of the present application, the stirring time of the K-biphenyl solution with the red phosphorus added is 2 hours to 30 hours, preferably 6 hours to 15 hours, and most preferably, 10 hours to 12 hours. In the preferred time range, the red phosphorus and K-biphenyl can react fully to obtain the ideal reaction product.

According to some implementations of the present application, the stirring condition of the K-biphenyl solution with the red phosphorus added is 25° C. to 40° C., and preferably 25° C. to 35° C. Under the above reaction conditions, the K-biphenyl can react with the red phosphorus fully to obtain the product KₚP_{q}.

According to some implementations of the present application, the soaking time of the KₚP_{q} solid in the electrolyte is 6 hours to 48 hours, preferably 12 hours to 30 hours, and most preferably, 20 hours to 24 hours. Within the preferred soaking time, the KₚP_{q} solid can be fully dissolved in the electrolyte solvent to reach a certain amount of addition.

According to some implementations of the present application, the amount of the KₚP_{q} solid soaked in the electrolyte is 0.2 g/L to 10.0 g/L, preferably 1.0 g/L to 5.0 g/L, and most preferably, 1.2 g/L to 3.0 g/L. Under the above reaction conditions, the electrolyte with the KₚP_{q} additive dissolved is obtained, and can reach a proper concentration.

The present application further discloses a preparation method of a phosphide. The phosphide is LiₓP_{y}, where 0<x≤3 and 0<y≤11, and the specific preparation method includes the step that red phosphorus is added to a Li-biphenyl solution, and stirred at a certain temperature to obtain a LiₓP_{y} solid by centrifuging and evaporating the solvent to dryness. Wherein, the optional solvent of the Li-biphenyl solution is one or more of the tetrahydrofuran, the dimethoxyethane, the tetraethylene glycol dimethyl ether and the diglyme.

In the liquid-solid reaction preparation method, specific LiₓP_{y} products can be obtained by regulating a Li—P ratio. When these products are soaked in the electrolyte, soluble components (such as LiP₄, LiP₅, LiP₇, LiP₈ and LiP₁₀) with higher compatibility with the electrolyte solvent may be dissolved, and thus such products are more suitable to serve as electrolyte capacity compensation additives.

According to some implementations of the present application, the solvent of the Li-biphenyl solution is selected from the tetrahydrofuran and the dimethoxyethane. As the boiling points of the two solvents are lower, the solvents are easy to evaporate after synthesis to obtain the pure LiₓP_{y}.

According to some implementations of the present application, the concentration of the Li-biphenyl solution is 0.2 mol/L to 2.0 mol/L. The concentration of the Li-biphenyl solution is preferably 0.8 mol/L to 1.2 mol/L, and the concentration of the Li-biphenyl solution is most preferably, 1.0 mol/L to 1.1 mol/L. In the preferred concentration of the Li-biphenyl solution, the yield of the obtained lithium polyphosphates is higher.

According to some implementations of the present application, the molar ratio of the amount of the red phosphorus added to the Li-biphenyl solution to Li is 1:5 to 11:1, preferably 1:3 to 5:1, and most preferably, 1:3 to 7:3. In the preferred range, the soluble product of the obtained lithium polyphosphates in the electrolyte is higher in solubility, and can achieve a better effect of capacity compensation.

According to some implementations of the present application, the stirring time of the Li-biphenyl solution with the red phosphorus added is 2 hours to 30 hours, preferably 6 hours to 15 hours, and most preferably, 10 hours to 12 hours. In the preferred time range, the red phosphorus and the Li-biphenyl can react fully to obtain an ideal reaction product.

According to some implementations of the present application, the stirring condition of the Li-biphenyl solution with the red phosphorus added is 25° C. to 40° C., and preferably 25° C. to 35° C. Under the above reaction conditions, the Li-biphenyl can react with the red phosphorus fully to obtain the pure LiₓP_{y}.

The present application further discloses a preparation method of a phosphide NaₘPₙ, where 0<m≤3 and 0<n≤11, and the specific preparation method includes the step: red phosphorus is added to a Na-biphenyl solution, and stirred at a certain temperature to obtain a NaₘPₙ solid by centrifuging and evaporating the solvent to dryness. Wherein, the optional solvent of the Na-biphenyl solution is one or more of the tetrahydrofuran, the dimethoxyethane, the tetraethylene glycol dimethyl ether and the diglyme.

In the liquid-solid reaction preparation method, specific NaₘPₙ products can be obtained by regulating a Na—P ratio. When these products are soaked in the electrolyte, soluble components (such as NaP₄, NaP₅, NaP₇ and NaP₁₀) with higher compatibility with the electrolyte solvent may be dissolved, and thus, such products are more suitable to serve as electrolyte capacity compensation additives.

According to some implementations of the present application, the solvent of the Na-biphenyl solution is selected from the tetrahydrofuran and the dimethoxyethane. As the boiling points of the two solvents are lower, the solvents are easy to evaporate after synthesis to obtain the pure NaₘPₙ.

According to some implementations of the present application, the concentration of the Na-biphenyl solution is 0.2 mol/L to 2.0 mol/L. The concentration of the Na-biphenyl solution is preferably 0.8 mol/L to 1.2 mol/L, and the concentration of the Na-biphenyl solution is most preferably 1.0 mol/L to 1.1 mol/L. In the preferred concentration of the Na-biphenyl solution, the yield of the obtained sodium polyphosphates is higher.

According to some implementations of the present application, the molar ratio of the amount of the red phosphorus added to the Na-biphenyl solution to Na is 1:5 to 11:1, preferably 1:3 to 5:1, and most preferably, 1:3 to 7:3. In the preferred range, the soluble product of the obtained sodium polyphosphates in the electrolyte is higher in solubility, and can achieve a better effect of capacity compensation.

According to some implementations of the present application, the stirring time of the Na-biphenyl solution with the red phosphorus added is 2 hours to 30 hours, preferably 6 hours to 15 hours, and most preferably, 10 hours to 12 hours. In the preferred time range, the red phosphorus and the Na-biphenyl can react fully to obtain an ideal reaction product.

According to some implementations of the present application, the stirring condition of the Na-biphenyl solution with the red phosphorus added is 25° C. to 40° C., and preferably 25° C. to 35° C. Under each reaction condition, the Na-biphenyl can react with the red phosphorus fully to obtain the pure NaₘPₙ.

The present application further discloses a preparation method of a phosphide KₚP_{q}, where 0<p≤3 and 0<q≤11, and the specific preparation method includes the step: red phosphorus is added to a K-biphenyl solution, and stirred at a certain temperature to obtain a KₚP_{q} solid by centrifuging and evaporating the solvent to dryness. Wherein, the optional solvent of K-biphenyl solution is one or more of the tetrahydrofuran, the dimethoxyethane, the tetraethyleneglycol dimethyl ether and the diglyme.

In the liquid-solid reaction preparation method, specific KₚP_{q} products can be obtained by regulating a K—P ratio. When these products are soaked in the electrolyte, soluble components (such as KP₄, KP₅, KP₇ and K₃P₇) with higher compatibility with the electrolyte solvent will be dissolved, and thus, such products are more suitable to serve as an electrolyte capacity-compensation additive.

According to some implementations of the present application, the solvent of K-biphenyl solution is selected from the tetrahydrofuran and the dimethoxyethane. As the boiling points of the two solvents are lower, the solvents are easy to evaporate after synthesis to obtain the pure KₚP_{q}.

According to some implementations of the present application, the concentration of the K-biphenyl solution is 0.2 mol/L to 2.0 mol/L. The concentration of the K-biphenyl solution is preferably 0.8 mol/L to 1.2 mol/L, and the concentration of the K-biphenyl solution is most preferably, 1.0 mol/L to 1.1 mol/L. In the preferred concentration of the K-biphenyl solution, the yield of the obtained potassium polyphosphates is higher.

According to some implementations of the present application, the molar ratio of the amount of the red phosphorus added to the K-biphenyl solution to K is 1:5 to 11:1, preferably 1:3 to 5:1, and most preferably, 1:3 to 7:3. In the preferred range, the soluble product of the obtained potassium polyphosphates in the electrolyte is higher in solubility, and can achieve a better effect of capacity compensation.

According to some implementations of the present application, the stirring time of the K-biphenyl solution with the red phosphorus added is 2 hours to 30 hours, preferably 6 hours to 15 hours, and most preferably, 10 hours to 12 hours. In the preferred time range, the red phosphorus and K-biphenyl can react fully to obtain the ideal reaction product.

According to some implementations of the present application, the stirring condition of the K-biphenyl solution with the red phosphorus added is 25° C. to 40° C., and preferably 25° C. to 35° C. Under the above reaction conditions, the K-biphenyl can react with the red phosphorus fully to obtain the pure KₚP_{q}.

The present application further discloses an electrolyte for a secondary battery, and the electrolyte includes an electrolyte salt, an organic solvent and the above-mentioned capacity-compensation electrolyte additives. In the working process of the electrolyte, the additive may decompose prior to an electrolyte solvent and an electrolyte salt to release the active ions for compensating the capacity loss occurred in the first cycle and subsequent cycle processes of the battery, and therefore the cycle stability and energy density of the batter are improved.

According to some implementations of the present application, the organic solvent includes one or more of an ester solvent, an ether solvent, a sulfone solvent and a nitrile solvent. The phosphorus-containing substance includes LiₓP_{y}, NaₘPₙ and KₚP_{q}, which are higher in compatibility with the above solvents and may reach a certain solubility.

In the electrolyte during the working process of the battery, by taking LiP₇ as an example, the following reaction can occur:

LiP₇→Li⁺P₇⁻

After extensive testing validation, the applicant found that the LiₓP_{y}, the NaₘPₙ and the KₚP_{q} were higher in compatibility with common electrolytes, and extremely wide in practicability, wherein the organic solvent may be one or mixtures of more of the ester solvent, the ether solvent, the sulfone solvent and the nitrile solvent, and the proportion of the solvents may not be specifically limited, such as EC:DEC=1:1.

According to some implementations of the present application, the ester solvent is selected from one or more of ethylene carbonate (EC), diethyl carbonate (DEC), dimethyl carbonate (DMC), ethyl methyl carbonate (EMC), propylene carbonate (PC), chlorocarbonate (Cl MC), ethyl propionate (EP) and propyl propionate (PP);

According to some implementations of the present application, the ether solvent is selected from one or more of dimethoxyethane (DME), 1,3-dioxolame (1,3-DOL) and diglyme (DG);

According to some implementations of the present application, the sulfone solvent is selected from one or more of sulfolane (SL) and dimethyl sulfoxide (DMSO); and

According to some implementations of the present application, the nitrile solvent is selected from one or more of acetonitrile (AN), succinonitrile (SN) and hexanedinitrile (HN). The phosphorus-containing substance includes LiₓP_{y}, NaₘPₙ and KₚP_{q}, which are higher in compatibility with the above additives and can reach a certain solubility, to achieve the effect of the electrolyte additives.

According to some implementations of the present application, in the electrolyte salt, the electrolyte for the lithium-ion battery includes one or a combination of more of lithium hexafluorophosphate (LiPF₆), lithium tetrafluoroborate (LiBF₄), lithium perchlorate (LiClO₄), lithium hexafluoroarsenate (LiAsF₆), lithium bis(oxalate)borate (LiBOB), lithium difluoro(oxalato)borate (LiDFOB), lithium bis(fluorosulfonyl)imide (LiFSI), lithium bis(trifluoromethanesulfonyl)imide (LiTFSI), lithium trifluoromethanesulfonate (LiCF₃SO₃), lithium bis(trifluoromethylsulfonyl)imide (LiN(CF₃SO₂)₂) and lithium tetrafluorooxalate phosphate (LiPF₄(C₂O₄)). According to some implementations of the present application, in the electrolyte salt, the electrolyte for the lithium-ion battery is selected from LiPF₆, LiBF₄, LiBOB, LiDFOB, LiFSI and LiTFSI. The above lithium salts do not react with the lithium polyphosphate chemically, and are higher in compatibility.

According to some implementations of the present application, the electrolyte salt for the sodium-ion battery includes NaClO₄ and/or NaPF₆. The above sodium salts do not react with the sodium polyphosphate chemically, and are higher in compatibility.

The electrolyte salt for the potassium-ion battery includes one or more of potassium hexafluorophosphate (KPF₆), potassium bis(trifluoromethanesulfonly)imide (KTFSI) and potassium bis(fluorosulfonyl)imide (KFSI). The above electrolyte salts can be dissolved in the electrolyte properly, do not react with the potassium polyphosphate chemically, and are higher in compatibility.

According to some implementations of the present application, the mass percentage of the electrolyte additive dissolved in the electrolyte is 0.1% to 25%.

According to some implementations of the present application, the mass percentage of the electrolyte additive dissolved in the electrolyte is 8% to 12%.

According to some implementations of the present application, the mass percentage of the electrolyte additive dissolved in the electrolyte is most preferably 10%. Too few additives may result in insufficient compensation for capacity losses caused by volume expansion and pulverization of electrodes in the cycle process, while introduction of too many additives may result in excessive additive mass, leading to reduction in whole energy density of the battery.

The present application further discloses a preparation method of the electrolyte for the secondary battery, the electrolyte includes an electrolyte salt, an organic solvent and an electrolyte additive LiₓP_{y}, NaₘPₙ or KₚP_{q}, where 0<x≤3, 0<y≤11, 0<m≤3, 0<n≤11, 0<p≤3, and 0<q≤11, and the preparation method of the electrolyte includes:

red phosphorus is added to a Li-biphenyl solution, and stirred at a certain temperature to obtain a LiₓP_{y} solid, a NaₘPₙ solid or a KₚP_{q} solid; and the electrolyte salt is added to the electrolyte solvent for dissolving, and then the LiₓP_{y} solid, the NaₘPₙ solid or the KₚP_{q} solid is soaked in the electrolyte solvent for dissolving to obtain the electrolyte with the LiₓP_{y}, the NaₘPₙ or the KₚP_{q} dissolved respectively.

According to some implementations of the present application, the additive is added to the electrolyte in the inert gas atmosphere, such as the argon atmosphere. It is the same as common liquid injection environment, and additional steps are not required in industrial production.

The present application further discloses a secondary ion battery, including a cathode, an anode, a separator and the electrolyte.

According to some implementations of the present application, the secondary ion battery includes a lithium-ion battery, a sodium-ion battery or a potassium-ion battery; and

According to some implementations of the present application, the cathode of the lithium-ion battery is selected from one or more of LiCoO₂, LiNiO₂, LiMn₂O₄, LiNi_{0.5}Mn_{1.5}O₄, Li₃V₂(PO₄)₃, LiFePO₄, LiNiₓCo_{y}Mn_{1-x-y}O₂, LiNiₓCo_{y}Al_{1-x-y}O₂ and S, and preferably, the LiCoO₂, the LiMn₂O₄, the LiFePO₄, the LiNi_{0.5}Co_{0.2}Mn_{0.3}O₂ and the LiNi_{0.8}Co_{0.1}Mn_{0.1}. The above preferred cathode materials may be compatible with the lithium polyphosphate, and the lithium polyphosphate may decompose in a working voltage window of the cathode materials to achieve the effects of capacity compensation and CEI stabilization.

According to some implementations of the present application, the cathode of the sodium-ion battery is selected from one or more of sodium cobaltate, sodium manganate, sodium nickelate, sodium vanadate, sodium manganese phosphate, sodium iron phosphate, sodium vanadium phosphate, nickel-iron sodium manganate and sodium-rich sodium manganate, and preferably, the sodium manganate, the sodium vanadate and the sodium vanadium phosphate. The above preferred cathode materials may be compatible with the sodium polyphosphate, and the sodium polyphosphate will decompose in a working voltage window of the cathode materials to achieve the effects of capacity compensation and CEI stabilization.

According to some implementations of the present application, the cathode of the potassium-ion battery is selected from one or more of a Prussian blue analogue containing potassium, KMO₂, K₃V₂(PO₄)₂F₃, KVOPO₄, KVPO₄F, K₄Fe₃(PO₄)₂(P₂O₇) and KFeC₂O₄, and preferably, the Prussian blue analogue containing potassium and the K₄Fe₃(PO₄)₂(P₂O₇), where M in the KMO₂ is a transition metal. The above preferred cathode materials may be compatible with the potassium polyphosphate, and the potassium polyphosphate will decompose in a working voltage window of the cathode materials to achieve the effects of capacity compensation and CEI stabilization.

According to some implementations of the present application, the anode is selected from artificial graphite, natural graphite, a carbon-based anode, a carbon nanotube, silicon and alloys thereof, tin and alloys thereof, germanium and alloys thereof, a phosphorus-based anode, a lithium metal, Li₄Ti₅O₁₂ or a transition metal compound MᵢXₖ, where, M is a metal element, X is selected from O, S, F or N, 0<i<3, and 0<k<4.

According to some implementations of the present application, the MᵢXₖ is selected from Fe₂O₃, Co₃O₄, MoS₂ and SnO₂.

According to some implementations of the present application, the anode is preferably selected from the graphite, the red phosphorus-CNT complex the nano-silicon, the Li metal, the MoS₂ and the black phosphorus-graphite complex. The above preferred anode materials may be compatible with polyphosphides, and the polyphosphides may decompose in a working voltage window of the cathode materials to achieve the effects of capacity compensation and SEI stabilization.

According to some implementations of the present application, a cathode/anode system is selected from the group consisting of LiNi_{0.5}Co_{0.2}Mn_{0.3}O₂/red phosphorus-CNT, LiNi_{0.5}Co_{0.2}Mn_{0.3} O₂/nano-silicon, LiNi_{0.8}Co_{0.1}Mn_{0.1}O₂/graphite, LiCoO₂/SnO₂, LiMn₂O₄/Li metal, LiFePO₄/graphite, LiFePO₄/MoS₂, NaV₆O₁₅/black phosphorus-graphite complex and potassium-containing Prussian blue/graphite. In the above battery system, the additives LiₓP_{y}, NaₘPₙ and KₚP_{q} may decompose in a voltage window of the battery preferentially, and form uniform and stable CEI and SEI films on the surfaces of the cathode and the anode.

According to some implementations of the present application, the concentration of the electrolyte salt is not specifically limited. For example, the concentration is 1.0 mol/L or 1.2 mol/L.

According to some implementations of the present application, the electrolyte may further include other additives. As the additive in the present disclosure is higher in compatibility with the electrolyte, selection of other additives is not specifically limited. Those skilled in the art may add common additives (such as film-forming additives, that is, fluoroethylene carbonate (FEC), vinylene carbonate (VC) and phenyl sulfone (PS)) according to specific battery systems.

The present application further discloses the application of the additive, the electrolyte and the secondary ion battery in the field of secondary rechargeable batteries.

The present disclosure will be described in detail below with reference to specific embodiments. Apparently, the listed embodiments are only a part of embodiments rather than all embodiments. Features in the embodiments can be mutually combined. All other embodiments obtained by those ordinarily skilled in art based on the present disclosure without involving creative labor should fall within the protection scope of the present disclosure. Conditions used by comparative examples are shown in Table 1.

### Embodiment 1

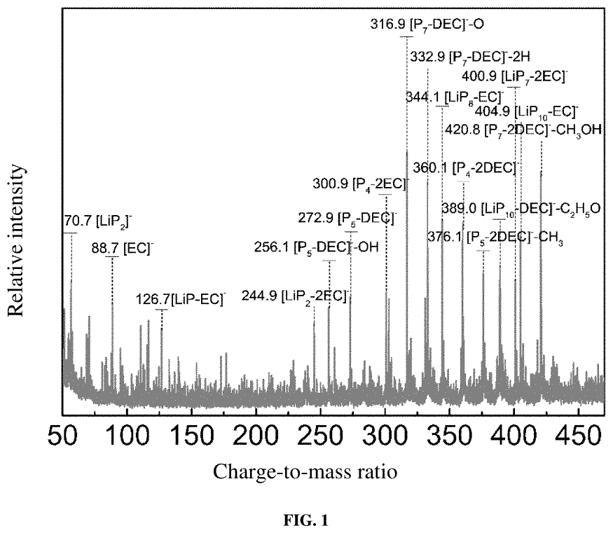

An electrolyte in this embodiment includes organic solvents according to a volume ratio of EC/EMC/DMC=1/1/1, and a 1.0 mol/L LiFSI electrolyte salt is dissolved. Red phosphorus is added to a 1.0 mol/L Li-biphenyl tetrahydrofuran solution, a molar ratio of the red phosphorus to Li-biphenyl is 1:3, and the solution is stirred at 25° C. for 12 hours to obtain a solid product. The product is Li_{2.9}P through inductively coupled plasma (ICP) elemental analysis. The phosphorus-containing compound is added to the electrolyte, and soaked for 20 hours to obtain the electrolyte with lithium polyphosphates dissolved. In the dissolved product, Li:P=1:7.8. Through mass spectrometry (as shown in FIG. 1), the additives dissolved in the electrolyte solvent mainly include LiP₅, LiP₇ and LiP₁₀, and the mass percentage of the additives is 10%. Taking LiNi_{0.8}Co_{0.1}Mn_{0.1}O₂ as a cathode materials and artificial graphite as an anode material, the above electrolyte is added for assembling a CR2032 type coin cell.

### Embodiment 2

An electrolyte in this embodiment includes organic solvents according to a volume ratio, namely EC/DMC=2/1, and a 1.2 mol/L LiBF₄ electrolyte salt is dissolved in the electrolyte. Red phosphorus is added to a 0.8 mol/L Li-biphenyl dimethoxyethane solution, a molar ratio of the red phosphorus to Li-biphenyl is 7:1, and the solution is stirred at 30° C. for 15 hours to obtain a solid product. The product is LiP_{6.4} through ICP elemental analysis. The phosphorus-containing compound is added to the electrolyte, and soaked for 12 hours to obtain the electrolyte with lithium polyphosphates dissolved. In the dissolved product, Li:P=1:8.5. Through mass spectrometry, the additives dissolved in the electrolyte solvent mainly include LiP₇, LiP₈ and LiP₁₀, and the mass percentage of the additives is 5%. Taking LiNi_{0.5}Co_{0.2}Mn_{0.3}O₂ as a cathode material and nano-silicon as an anode material, the above electrolyte is added for assembling a CR2032 type coin cell.

### Embodiment 3

An electrolyte in this embodiment includes organic solvents according to a volume ratio of EC/DEC=1/1, and a 1.0 mol/L LiPF₆ electrolyte salt is dissolved. Red phosphorus is added to a 1.0 mol/L Li-biphenyl tetrahydrofuran solution, a molar ratio of the red phosphorus to Li-biphenyl is 2:1, and the solution is stirred at 30° C. for 10 hours to obtain a solid product. The product is LiP_{1.9} through ICP elemental analysis. The phosphorus-containing compound is added to the electrolyte, and soaked for 20 hours to obtain the electrolyte with lithium polyphosphates dissolved. In the dissolved product, Li:P=1:5.6. Through mass spectrometry, the additives dissolved in the electrolyte solvent mainly include LiP, LiP₄ and LiP₈, and the mass percentage of the additives is 15%. Taking LiNi_{0.5}Co_{0.2}Mn_{0.3}O₂ as a cathode material and the red phosphorus and CNT (the mass ratio is 7:3) subjected to ball milling as anode materials, the above electrolyte is added for assembling a CR2032 type coin cell.

### Embodiment 4

An electrolyte in this embodiment includes organic solvents according to a volume ratio of EC/DEC=1/1, and a 1.2 mol/L LiTFSI electrolyte salt is dissolved in the electrolyte. Red phosphorus is added to a 1.2 mol/L Li-biphenyl dimethoxyethane solution, a molar ratio of the red phosphorus to Li-biphenyl is 5:1, and the solution is stirred at 35° C. for 20 hours to obtain a solid product. The product is LiP_{4.8} through ICP elemental analysis. The phosphorus-containing compound is added to the electrolyte, and soaked for 24 hours to obtain the electrolyte with lithium polyphosphates dissolved. In the dissolved product, Li:P=1:5.2. Through mass spectrometry, the additives dissolved in the electrolyte solvent mainly include LiP, LiP₄, LiP₅ and LiP₁₀, and the mass percentage of the additives is 0.1%. Taking LiCoO₂ as a cathode material and SnO₂ as an anode material, the above electrolyte is added for assembling a CR2032 type coin cell.

### Embodiment 5

An electrolyte in this embodiment includes organic solvents according to a volume ratio of 1, 3-DOL/DME=1/1, and a 1.0 mol/L LiBOB electrolyte salt is dissolved in the electrolyte. Red phosphorus is added to a 2.0 mol/L Li-biphenyl dimethoxyethane solution, a molar ratio of the red phosphorus to Li-biphenyl is 3:1, and the solution is stirred at 40° C. for 2 hours to obtain a solid product. The product is LiP_{2.7} through ICP elemental analysis. The phosphorus-containing compound is added to the electrolyte, and soaked for 48 hours to obtain the electrolyte with lithium polyphosphates dissolved. In the dissolved product, Li:P=1:6.3. Through mass spectrometry, the additives dissolved in the electrolyte solvent mainly include LiP, LiP₅ and LiP₁₀, and the mass percentage of the additives is 25%. Taking LiMn₂O₄ as a cathode material and a Li metal as an anode material, the above electrolyte is added for assembling a CR2032 type coin cell.

### Embodiment 6

An electrolyte in this embodiment includes organic solvents according to a volume ratio of EC/DEC=1/1, and a 1.0 mol/L LiPF₆ electrolyte salt is dissolved. Red phosphorus is added to a 1.0 mol/L Li-biphenyl tetrahydrofuran solution, a molar ratio of the red phosphorus to Li-biphenyl is 7:3, and the solution is stirred at 30° C. for 30 hours to obtain a solid product. The product is Li₃P_{6.7} through ICP elemental analysis. The phosphorus-containing compound is added to the electrolyte, and soaked for 6 hours to obtain the electrolyte with lithium polyphosphates dissolved. In the dissolved product, Li:P=1:7.3. Through mass spectrometry, the additives dissolved in the electrolyte solvent mainly include LiP₈, LiP₇ and LiP₁₀, and the mass percentage of the additives is 8%. Taking LiFePO₄ as a cathode material and graphite as an anode material, the above electrolyte is added for assembling a CR2032 type coin cell.

### Embodiment 7

An electrolyte in this embodiment includes organic solvents according to a volume ratio of EC/DEC=1/1, and a 1.0 mol/L LiPF₆ electrolyte salt is dissolved. Red phosphorus is added to a 1.0 mol/L Li-biphenyl tetrahydrofuran solution, a molar ratio of the red phosphorus to Li-biphenyl is 4:1, and the solution is stirred at 25° C. for 11 hours to obtain a solid product. The product is LiP_{3.8} through ICP elemental analysis. The phosphorus-containing compound is added to the electrolyte, and soaked for 20 hours to obtain the electrolyte with lithium polyphosphates dissolved. In the dissolved product, Li:P=1:5.4. Through mass spectrometry, the additives dissolved in the electrolyte solvent mainly include LiP, LiP₅ and LiP₇, and the mass percentage of the additives is 10%. Taking LiFePO₄ as a cathode material and MoS₂ as an anode material, the above electrolyte is added for assembling a CR2032 type coin cell.

### Embodiment 8

An electrolyte in this embodiment includes organic solvents according to a volume ratio of EC/DMC=1/1, and a 1.0 mol/L NaClO₄ electrolyte salt is dissolved in the electrolyte. Red phosphorus is added to a 1.0 mol/L Na-biphenyl tetrahydrofuran solution, a molar ratio of the red phosphorus to Na-biphenyl is 7:3, and the solution is stirred at 25° C. for 12 hours to obtain a solid product. The product is Na₃P_{6.7} through ICP elemental analysis. The phosphorus-containing compound is added to the electrolyte, and soaked for 20 hours to obtain the electrolyte with sodium polyphosphates dissolved. In the dissolved product, Na:P=1:5.4. Through mass spectrometry, the additives dissolved in the electrolyte solvent mainly include NaP₅ and NaP₇, and the mass percentage of the additives is 10%. Taking NaV₆O₁₅ (sodium vanadate) as a cathode material and a black phosphorus-graphite complex as an anode material, the above electrolyte is added for assembling a CR2032 type coin cell.

### Embodiment 9

An electrolyte in this embodiment includes organic solvents according to a volume ratio of EC/DEC=1/1, and a 1.0 mol/L KFSI electrolyte salt is dissolved in the electrolyte. Red phosphorus is added to a 1.0 mol/L K-biphenyl tetrahydrofuran solution, a molar ratio of the red phosphorus to K-biphenyl is 1:3, and the solution is stirred at 25° C. for 12 hours to obtain a solid product. The product is K_{2.9}P through ICP elemental analysis. The phosphorus-containing compound is added to the electrolyte, and soaked for 20 hours to obtain the electrolyte with potassium polyphosphates dissolved. In the dissolved product, K:P=1:5.8. Through mass spectrometry, the additives dissolved in the electrolyte solvent mainly include KP₇ and K₃P₇, and the mass percentage of the additives is 10%. The electrolyte salt is 1.0 mol/L KFSI, the additive is KP₇, and the mass percentage of the additive is 10%. Taking potassium-containing Prussian blue as a cathode material and graphite as an anode material, the above electrolyte is added for assembling a CR2032 type button battery.

### Comparative Example 1

An electrolyte in this embodiment includes organic solvents according to a volume ratio of EC/DEC=1/1, and an electrolyte salt is 1.0 mol/L LiPF₆. Taking LiNi_{0.8}Co_{0.1}Mn_{0.1}O₂ as a cathode materials and artificial graphite as an anode material, the above electrolyte is added for assembling a CR2032 type button battery.

### Comparative Example 2

An electrolyte in this embodiment includes organic solvents according to a volume ratio of EC/DEC=1/1, and an electrolyte salt is 1.0 mol/L LiPF₆. Taking LiFePO₄ as a cathode material and graphite as an anode material, the above electrolyte is added for assembling a CR2032 type button battery.

### Comparative Example 3

An electrolyte in this embodiment includes organic solvents according to a volume ratio of EC/DMC=1/1, and an electrolyte salt is 1.0 mol/L NaClO₄. Taking NaV₆O₁₅ (sodium vanadate) as a cathode material and graphite as an anode material, the above electrolyte is added for assembling a CR2032 type button battery.

### Comparative Example 4

An electrolyte in this embodiment includes organic solvents according to a volume ratio of EC/DEC=1/1, and an electrolyte salt is 1.0 mol/L KFSI. Taking potassium-containing Prussian blue as a cathode material and graphite as an anode material, the above electrolyte is added for assembling a CR2032 type button battery.

TABLE 1

| No. | Group | Additive | Electrolyte salt | Solvent | Cathode/anode |
|---|---|---|---|---|---|
| 1 | Embodiment 1 | LiP_{7.8} 10 wt % | l.0 mol/L LiPF₆ | EC/EMC/DMC = 1/1/1 | LiNi_{0.8}Co_{0.1}Mn_{0.1}O₂/ |
| | | (LiP₅, LiP₇, LiP₁₀) | | | Artificial graphite |
| 2 | Embodiment 2 | LiP₈.₅ 5 wt % | 1.2 mol/L LiBF₄ | EC/DEC = 2/1 | LiNi_{0.5}Co_{0.2}Mn_{0.3}O₂/ |
| | | (LiP₇, LiP₈, LiP₁₀) | | | Nano-silicon |
| 3 | Embodiment 3 | LiP₅.₆ 15 wt % | l.0 mol/L LiPF₆ | EC/DEC = 1/1 | LiNi_{0.5}Co_{0.2}Mn_{0.3}O₂/ |
| | | (LiP, LiP₄, LiP₈) | | | Red phosphorus-CNT |
| 4 | Embodiment 4 | LiP_{5.2} 0.1 wt % | 1.2 mol/L LiTFSI | EC/DEC = 1/1 | LiCoO₂/SnO₂ |
| | | (LiP, LiP₄, LiP₅, LiP₁₀) | | | |
| 5 | Embodiment 5 | LiP_{6.3} 25 wt % | l.0 mol/L LiBOB | 1,3-DOL/DME = 1/1 | LiMn₂O₄/Li metal |
| | | (LiP, LiP₅, LiP₁₀) | | | |
| 6 | Embodiment 6 | LiP_{7.3} 8 wt % | l.0 mol/L LiPF₆ | EC/DEC = 1/1 | LiFePO₄/graphite |
| | | (LiP₅, LiP₇, LiP₁₀) | | | |
| 7 | Embodiment 7 | LiP_{5.4} 10 wt % | l.0 mol/L LiPF₆ | EC/DEC = 1/1 | LiFePO₄/MoS₂ |
| | | (LiP, LiP₅, LiP₇) | | | |
| 8 | Embodiment 8 | NaP_{5.4} 10 wt % | 1.0 mol/L NaClO₄ | EC/DMC = l/l | NaV₆O₁₅/black |
| | | (NaP₅, NaP₇) | | | phosphorus-graphite |
| | | | | | complex |
| 9 | Embodiment 9 | K₂.₉P 10 wt % | 1.0 mol/L [symbol] KFSI | EC/DEC = 1/1 | Potassium-containing |
| | | (KP₇, K₃P₇) | | | Prussian blue/graphite |
| 10 | Comparative | No | l.0 mol/L LiPF₆ | EC/DEC = 1/1 | LiNi_{0.8}Co_{0.1}Mn_{0.1}O₂/ |
| | Example 1 | | | | Artificial graphite |
| 11 | Comparative | No | l.0 mol/L LiPF₆ | EC/DEC = 1/1 | LiFePO₄/graphite |
| | Example 2 | | | | |
| 12 | Comparative | No | 1.0 mol/L NaClO₄ | EC/DMC = l/l | NaV₆O₁₅/black |
| | Example 3 | | | | phosphorus-graphite |
| | | | | | complex |
| 13 | Comparative | No | l.0 mol/L KFSI | EC/DEC = 1/1 | Potassium-containing |
| | Example 4 | | | | Prussian blue/graphite |

The battery is activated at a charge-discharge current density of 20 mAh g⁻¹/20 mAh g⁻¹ in an environment at 25° C. within a voltage interval of 3.0 V to 4.3 V in Embodiments 1 to 5 and 9 and the comparative examples 1 and 4, and then cycle performance tests are conducted at 100 mAh g⁻¹/100 mAh g⁻¹ within the voltage interval of 3.0 V to 4.3 V. The capacity of the activated battery after the first discharge was D1, meanwhile, the capacity of the battery after 200 cycles was recorded as D200, D200/D1 was the capacity retention rate of the battery, and obtained results were shown in Table 2.

The battery is activated at a charge-discharge current density of 20 mAh g⁻¹/20 mAh g⁻¹ in an environment at 25° C. within a voltage interval of 2.0 V to 3.8 Vin the embodiments 6 to 8 and the comparative examples 2 and 3, and then cycle performance tests are conducted at 100 mAh g⁻¹/100 mAh g⁻¹ within the voltage interval of 2.0 V to 3.8 V. The capacity of the activated battery after the first discharge was D1, meanwhile, the capacity of the battery after 200 cycles was recorded as D200, D200/D1 was the capacity retention rate of the battery, and obtained results were shown in Table 2.

TABLE 2

| | | First-cycle | | Capacity |
|---|---|---|---|---|
| | | coulombic | D1 | retention |
| No. | Group | efficiency (%) | (mAh g⁻¹) | rate (%) |
| 1 | Embodiment 1 | 84.4 | 204.1 | 74.3 |
| 2 | Embodiment 2 | 84.5 | 207.5 | 71.0 |
| 3 | Embodiment 3 | 84.7 | 211.9 | 72.6 |
| 4 | Embodiment 4 | 85.0 | 212.4 | 73.4 |
| 5 | Embodiment 5 | 84.9 | 143.4 | 69.2 |
| 6 | Embodiment 6 | 88.2 | 145.8 | 79.9 |
| 7 | Embodiment 7 | 86.9 | 148.3 | 70.6 |
| 8 | Embodiment 8 | 85.6 | 120.2 | 84.0 |
| 9 | Embodiment 9 | 61.2 | 109.2 | 73.1 |
| 10 | Comparative | 84.3 | 202.3 | 52.0 |
| | example 1 | | | |
| 11 | Comparative | 84.1 | 142.9 | 67.0 |
| | example 2 | | | |
| 12 | Comparative | 83.4 | 118.5 | 74.3 |
| | example 3 | | | |
| 13 | Comparative | 60.7 | 105.6 | 60.3 |
| | example 4 | | | |

FIG. 1 is a mass spectrum of a product formed by adding red phosphorus to a 1.0 mol/L tetrahydrofuran solution of Li-biphenyl (a molar ratio of the red phosphorus to Li-biphenyl is 3:1), stirring the solution at 25° C. for 12 hours, centrifuging and evaporating the solvent to dryness to obtain a LiₓP_{y} solid, and then soaking the LiₓP_{y} solid in EC:DEC=1:1 (v:v) for dissolving. It can be seen that the dissolved product mainly includes LiP₅, LiP₇, LiP₁₀ and solvates of these compounds in the ester solvents. These products are higher in solubility in the electrolyte, and may serve as capacity compensation additives in the electrolyte.

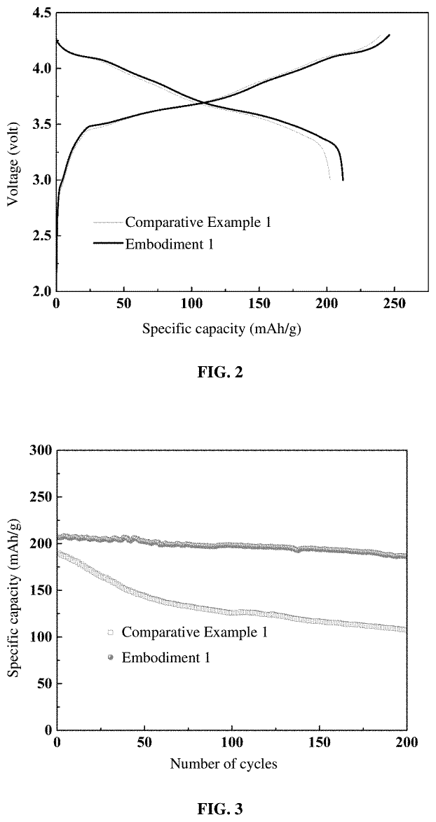

FIG. 2 and FIG. 3 illustrate first-cycle charge-discharge curves and cycle-specific capacity curves of batteries in the embodiment 1 and the comparative example 1. It can be seen that after 10 wt % of LiₓP_{y} was added, the initial Coulombic efficiency of the LiNi_{0.8}Co_{0.1}Mn_{0.1}O₂/artificial graphite full battery was improved, which showed that the LiₓP_{y} might compensate for loss of active ions due to formation of the SEI in the first cycle. The cyclic reversible specific capacity and capacity retention rate of the battery in the embodiment 1 were both higher than those in the comparative example 1, which showed that in the battery cycling process, the LiₓP_{y} could decompose to release the active ions and electrons for compensating for the capacity loss of each process, and play a role in stabilizing electrode-electrolyte interfaces to improve the cycle performance of the battery.

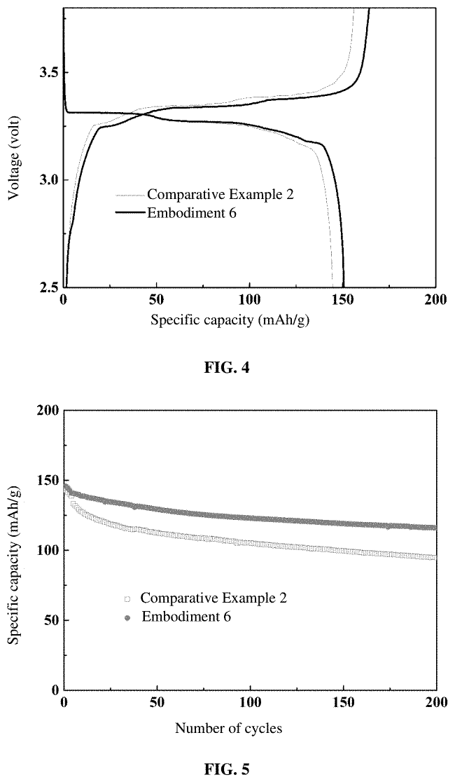

FIG. 4 and FIG. 5 illustrate first-cycle charge-discharge curves and cycle-specific capacity curves of batteries in the embodiment 6 and the comparative example 2. It can be seen that after 8 wt % of LiₓP_{y} was added, the initial Coulombic efficiency, cyclic reversible specific capacity and capacity retention rate of the LiFePO₄/graphite full battery were all higher than those in the comparative example 2, which showed that in the battery cycling process, the LiₓP_{y} could decompose to release the active ions and electrons for compensating the capacity loss of each process, and play a role in stabilizing electrode-electrolyte interfaces to improve the cycle performance of the battery.

From the dissolved product of the prepared LiₓP_{y} compound in the electrolyte solvent in Table 1, it can be seen that the LiP, LiP₄, LiP₅, LiP₇ and LiP₁₀ were higher in solubility, which might decompose to release the active ions and electrons for capacity compensation as the electrolyte additives.

From the capacity retention rate data of the lithium-ion battery system in Table 2, it can be seen that the capacity retention rates in the embodiment 1 and the embodiment 6 were higher, which showed that when the mass percentage of the additives was 8% to 12%, a better capacity compensation effect could be achieved.

From the data of the embodiment 8 and the comparative example 3 in Table 2, it can be seen that in the sodium-ion battery system, after 10 wt % of NaP₇ was added in the NaV₆O₁₅/black phosphorus-graphite complex full battery, the NaP₇ may play a role in compensating sodium ions and electrons to improve the initial Coulombic efficiency and cycle stability of the full battery.

From the data of the embodiment 9 and the comparative example 4 in Table 2, it can be seen that in the potassium-ion battery system, after 10 wt % of KP₇ was added in the potassium-containing Prussian blue/graphite full battery, the KP₇ may play a role in compensating potassium ions and electrons to improve the initial Coulombic efficiency and cycle stability of the full battery.

In conclusion, through extensive experimental validation, it can be found obviously from the data in Table 2 that in the lithium-ion battery, the initial Coulombic efficiency of the battery containing the LiₓP_{y} additive was improved compared with that in the comparative example, which proved that the LiₓP_{y} additive might play a role in capacity compensation in the first charging cycle; and the capacity retention rate in each battery system was improved compared with the comparative examples, which proved that the LiₓP_{y} additive might play a role in stabilizing the cathode CEI layer and the anode SEI layer to achieve better cycle performance. It can be seen from comparison that the content of the additives had a certain effect on the initial Coulombic efficiency and cycle stability of the battery. After the NaₘPₙ and KₚP_{q} were added to the sodium and potassium-ion batteries, the first-cycle reversible capacity of the battery was also improved, which was related to the phosphorus-containing substance decomposing to release the active ions, and the higher capacity retention rate of the battery was related to P_{y}⁻ synergistic participation in formation of the more stable CEI and SEI layers.

The embodiments shown in the present specification are not intended to limit the implementation of the present disclosure, but are merely descriptive of the present disclosure. Those ordinarily skilled in the art can also make other modifications or variations of different forms on the basis of the above illustration.

1. A capacity-compensation electrolyte additive, comprising one or more of LiₓP_{y}, NaₘPₙ and KₚP_{q}, where 0<x≤3, 0<y≤11, 0<m≤3, 0<n≤11, 0<p≤3 and 0<q≤11.

2. The electrolyte additive according to claim 1, wherein
the additive comprises one or more of the LiₓP_{y}, the NaₘPₙ and the KₚP_{q}, where 1≤x<3, 4≤y≤10, 1≤m<3, 4≤n≤10, 1≤p≤3 and 4≤q≤10.

3. The electrolyte additive according to claim 1, wherein
preferably, the LiₓP_{y} is selected from one or more of LiP₄, LiP₈, LiP₇, LiP₈ and LiP₁₀;
preferably, the NaₘPₙ is selected from one or more of NaP₄, NaP₅, NaP₇ and NaP₁₀; and
preferably, the KₚP_{q} is selected from one or more of KP₄, KP₅, KP₇ and K₃P₇.

4. The electrolyte additive according to claim 1, wherein
the additive is dissolved in an electrolyte, and the electrolyte is applied to a secondary battery; and
preferably, the secondary battery comprises a lithium-ion battery, a sodium-ion battery or a potassium-ion battery.

5. A preparation method of the capacity-compensation electrolyte additive according to claim 1, wherein the preparation method comprises:
adding red phosphorus to a Li-biphenyl solution, a Na-biphenyl solution or a K-biphenyl solution respectively, and stirring the solution at a certain temperature to obtain a LiₓP_{y} solid, a NaₘPₙ solid or a KₚP_{q} solid, where 0<x≤3, 0<y≤11, 0<m≤3, 0<n≤11, 0<p≤3 and 0<q≤11.

6. An application of the additive according to claim 1 in the field of electrolyte preparation.

7. The application according to claim 6, wherein the application comprises: soaking and dissolving one or more of the LiₓP_{y}, the NaₘPₙ and the KₚP_{q} in an electrolyte solvent to obtain the electrolyte containing the additive, where 0<x≤3, 0<y≤11, 0<m≤3, 0<n≤11, 0<p≤3 and 0<q≤11.

8. An electrolyte for a secondary battery, wherein the electrolyte comprises an electrolyte salt, an organic solvent and the capacity-compensation electrolyte additive according to claim 1.

9. The electrolyte according to claim 8, wherein the organic solvent comprises one or more of an ester solvent, an ether solvent, a sulfone solvent and a nitrile solvent;
preferably, the ester solvent is selected from one or more of ethylene carbonate, diethyl carbonate, dimethyl carbonate, ethyl methyl carbonate, propylene carbonate, chlorocarbonate, ethyl propionate and propyl propionate;
preferably, the ether solvent is selected from one or more of dimethoxyethane, 1,3-dioxolane and diglyme;
preferably, the sulfone solvent is selected from one or more of sulfolane and dimethyl sulfoxide; and
preferably, the nitrile solvent is selected from one or more of succinonitrile and hexanedinitrile.

10. The electrolyte according to claim 8, wherein the mass of the electrolyte additive accounts for 0.1%-25% of the total mass of the electrolyte.

11. A secondary ion battery, comprising a cathode, an anode, a separator and the electrolyte according to claim 8.

12. The secondary ion battery according to claim 11, wherein
the secondary battery comprises a lithium-ion battery, a sodium-ion battery or a potassium-ion battery;
preferably, the cathode of the lithium-ion battery is selected from one or more of LiCoO₂, LiNiO₂, LiMn₂O₄, LiNi_{0.5}Mn_{1.5}O₄, Li₃V₂(PO₄)₃, LiFePO₄, LiNiₐCo_{b}Mn_{1-a-b}O₂, LiNi_{c}Co_{d}Al_{1-c-d}O₂ and S, where 0<a<1, 0<b<1, 0<c<1, and 0<d<1;
preferably, the cathode of the sodium-ion battery is selected from one or more of sodium cobaltate, sodium manganate, sodium nickelate, sodium vanadate, sodium manganese phosphate, sodium iron phosphate, sodium vanadium phosphate, nickel-iron sodium manganate and sodium-rich sodium manganate; and
preferably, the cathode of the potassium-ion battery is selected from one or more of a Prussian blue analogue containing potassium, KMO₂, K₃V₂(PO₄)₂F₃, KVOPO₄, KVPO₄F, K₁₋ₑVP₂O₇, K₄Fe₃(PO₄)₂(P₂O₇) and KFeC₂O₄, where M in the KMO₂ is a transition metal, and 0<e<1.

13. The secondary ion battery according to claim 11, wherein the anode is selected from one or more of artificial graphite, natural graphite, a carbon-based anode, a carbon nanotube, silicon and alloys thereof, tin and alloys thereof, germanium and alloys thereof, a phosphorus-based anode, a lithium metal, Li₄Ti₅O₁₂ and a transition metal compound MᵢXₖ, where M is a metal element, X is selected from O, S, F or N, 0<i<3, and 0<k<4.

14. Application of a capacity-compensation electrolyte additive, comprising one or more of LiₓP_{y}, NaₘPₙ and KₚP_{q}, where 0<x≤3, 0<y≤11, 0<m≤3, 0<n≤11, 0<p≤3 and 0<q≤11,
an electrolyte for a secondary battery, wherein the electrolyte comprises an electrolyte salt, an organic solvent and the capacity-compensation electrolyte additive, and
a secondary ion battery, comprising a cathode, an anode, a separator and the electrolyte.

15. The method of claim 5, wherein
the additive comprises one or more of the LiₓP_{y}, the NaₘPₙ and the KₚP_{q}, where 1≤x<3, 4≤y≤10, 1≤m<3, 4≤n≤10, 1≤p≤3 and 4≤q≤10.

16. The method of claim 5, wherein
the additive comprises one or more of the LiₓP_{y}, the NaₘPₙ and the KₚP_{q}, where 1≤x<3, 4≤y≤10, 1≤m<3, 4≤n≤10, 1≤p≤3 and 4≤q≤10.

17. The method of claim 5, wherein
preferably, the LiₓP_{y} is selected from one or more of LiP₄, LiP₈, LiP₇, LiP₈ and LiP₁₀;
preferably, the NaₘPₙ is selected from one or more of NaP₄, NaP₅, NaP₇ and NaP₁₀; and
preferably, the KₚP_{q} is selected from one or more of KP₄, KP₅, KP₇ and K₃P₇.

18. The method of claim 5, wherein
the additive is dissolved in an electrolyte, and the electrolyte is applied to a secondary battery; and
preferably, the secondary battery comprises a lithium-ion battery, a sodium-ion battery or a potassium-ion battery.

19. The application of claim 6, wherein
the additive comprises one or more of the LiₓP_{y}, the NaₘPₙ and the KₚP_{q}, where 1≤x<3, 4≤y≤10, 1≤m<3, 4≤n≤10, 1≤p≤3 and 4≤q≤10.

20. The application of claim 6, wherein
preferably, the LiₓP_{y} is selected from one or more of LiP₄, LiP₈, LiP₇, LiP₈ and LiP₁₀;
preferably, the NaₘPₙ is selected from one or more of NaP₄, NaP₅, NaP₇ and NaP₁₀; and
preferably, the KₚP_{q} is selected from one or more of KP₄, KP₅, KP₇ and K₃P₇.
